(19) United States
(12) Patent Application Publication
(10) Pub. No.: US 2013/0139665 A1
(43) Pub. Date: Jun. 6, 2013

(54) Slicing Apparatus

(71) Applicant: Sealed Air Corporation (US), Elmwood Park, NJ (US)

(72) Inventors: Charles R. Sperry, Leeds, MA (US); Dennis F. McNamara, JR., Walpole, NH (US); Mark H. Salerno, Stratford, CT (US); Suzanne M. Scott, Springfield, VT (US); Vincent A. Piucci, JR., Southbridge, MA (US); Stephen D. Smith, Williamsburg, MA (US); John Koke, Duncan, SC (US); David M. Kroll, Westfield, MA (US)

(73) Assignee: SEALED AIR CORPORATION (US), Elmwood Park, NJ (US)

(21) Appl. No.: 13/688,797

(22) Filed: Nov. 29, 2012

Related U.S. Application Data
(60) Provisional application No. 61/566,210, filed on Dec. 2, 2011.

(51) Int. Cl. B26D 7/32; B26D 1/45; B26D 7/30; B26D 5/00

(52) U.S. Cl. CPC B26D 7/32; B26D 5/00; B26D 1/45; B26D 7/30
USPC 83/77; 83/167; 83/829

(57) ABSTRACT

An improved slicer having a reciprocating blade is disclosed. The use of a reciprocating blade allows the configuration and functionality of the slicer to be modified to address many of the deficiencies of current rotary slicers. The slicer operates without manual intervention, and includes the capability to automatically stack the sliced products. In other words, the food product to be sliced is placed on the slicer, and the slicer automatically slices the food product and stacks the sliced product, in a configuration that is presentable to the customer. In some embodiments, the machine is designed to have certain zones that can be cleaned or replaced, while the rest of the machine is never contaminated. In addition, the reciprocating blade is inexpensive and easily replaceable, thereby eliminating the need to sharpen the blade.

This application claims priority of U.S. Provisional Patent Application Ser. No. 61/566,210, filed Dec. 2, 2011, the disclosure of which is incorporated herein by reference in its entirety.

### BACKGROUND OF THE INVENTION

Deli slicers have not changed significantly in nearly 100 years. In the late 1800's, Wilhelm Van Berkel revolutionized meat slicing by inventing a device with a concave rotary blade and a carriage that slides the meat into the blade. It is credited as the first device to move the food into a spinning blade. The device was operated by a hand crank and flywheel. This machine was the forerunner of the ubiquitous Hobart slicer that is used today in countless locations to slice meat and cheese.

Over time, the hand crank was replaced by an electric motor. Interestingly, although Berkel's hand crank drove both the blade and the carriage, the majority of electric machines drive only the blade. Only the most advanced and expensive units automatically drive the carriage, the rest are operated manually.

Other modern improvements include antimicrobial additives in the external plastic components, a counter that triggers an indicator light to sharpen the blade, push button blade sharpening and various safety devices. Only very expensive, complex systems offer automatic stacking.

Materials and controls may have been improved over the years, but the slicer still uses a rotary blade and a carriage that moves the meat into the blade, as in Berkel's original.

Rotary blade slicers have numerous drawbacks, which people have learned to accept. One of these drawbacks is the inability of rotary slicers to automatically stack the sliced deli product. In most installations, the operator must move the carriage to slice the food product with one hand, then catch the slice with the other hand and stack it. The higher end of the deli slicers may automatically reciprocate the carriage, but do not include automatic stacking. An operator must still catch the slice and place it on the stack. If the slices are allowed to fall naturally, there is no mechanism to stack them neatly, and the result will be a messy pile of sliced product. This is not an acceptable presentation to the customer. Because of this, an operator is necessary for every slicing operation.

The slicers that do offer stacking are either high-cost counter-top device units such as those manufactured by Bizerba GmbH & Co. of Germany, or large scale processing equipment, such as those manufactured by Marel of Iceland. These all use complex stacking mechanisms and are designed for slicing large volumes of one type of product at a time. The Bizerba device comprises a rotary slicer coupled to a series of conveyors and rotating mechanisms. The Marel devices are fully automatic, high speed machines, generally using a guillotine, orbital or involute blade and conveyor systems, and are very large and are used in high volume processing plants. The current invention is aimed at a market segment that is low volume, high variability, customer service oriented, such as a supermarket delicatessen, sandwich shop, restaurant or other location where food products are sliced for sale or preparation.

Another drawback of existing slicers is the difficulty in cleaning them. Rotary blades, band saws, band blades and other continuous (non-reciprocating) devices carry by-products throughout their travel and deposit them on the inside surfaces of the apparatus. This makes cleaning more complicated. It also contributes to contamination and cross-contamination, since these by-products can be transferred back to the food product being sliced. Since many types of food products may be sliced by the same apparatus, this can transfer contaminants from one type of protein to another. It takes between 20 minutes and an hour to clean a rotary slicer, which must be cleaned thoroughly at least once a day. Additionally, it must be wiped down numerous times during the day. Since the rotary blade sends debris in all directions, the entire slicer must be cleaned.

Another drawback is safety. Cut fingers are common when operating rotary slicers. Cleaning a meat slicer is the leading cause of lacerations in deli departments, according to Argo Insurance Group, a provider of grocer's insurance. This results in numerous incidents each year that require an emergency room or doctor visit as well as Workers Compensation notification.

An improved slicer that addresses these issues, as well as other drawbacks, would be beneficial.

### SUMMARY

An improved slicer having a reciprocating blade is disclosed. The use of a reciprocating blade allows the configuration and functionality of the slicer to be modified to address many of the deficiencies of current rotary slicers. The slicer operates without manual intervention, and includes the capability to automatically stack the sliced products. In other words, the food product to be sliced is placed on the slicer, and the slicer automatically slices the food product and stacks the sliced product, in a configuration that is presentable to the customer. In some embodiments, the machine is designed to have certain zones that can be cleaned or replaced, while the rest of the machine is never contaminated. In addition, the reciprocating blade is inexpensive and easily replaceable, thereby eliminating the need to sharpen the blade.

### BRIEF DESCRIPTION OF THE DRAWINGS

FIG. 1 shows a view of a first embodiment of a slicer;

FIG. 2 shows the major components of a control system;

FIG. 3 shows a view of a second embodiment of a slicer;

FIG. 4 shows a view of the embodiment of FIG. 3 with the top cover removed;

FIG. 5 shows a view of the lower portion of the embodiment of FIG. 3;

FIG. 6 shows a view of the upper portion of the embodiment of FIG. 3;

FIG. 7 shows the major component of the control system of the embodiment of FIG. 3;

FIG. 8 shows an embodiment of a top cover having an integrated product holder;

FIG. 9 shows a third embodiment of a slicer;

FIG. 10 shows the motor assembly of the embodiment of FIG. 9;

FIG. 11 shows the underside of the tray used in the embodiment of FIG. 9;

FIG. 12 shows the base of the slicer of FIG. 9;

FIG. 13 shows a food item holder useful with the slicer of FIG. 9;

FIG. 14 shows the user interface of a software application that may be used in conjunction with the slicer;

FIGS. 15a and 15b show another embodiment of a slicer;

FIGS. 16a and 16b illustrate the limits of movement of the slicer of FIG. 15;

FIG. 17 shows a view of the housing used with the slicer of FIG. 15;

FIGS. 18a and 18b show the drive unit of the slicer of FIG. 15;

FIG. 19a is a cross section taken through A-A, indicated in FIG. 16b;

FIG. 19b is an isometric view of the drive unit of FIG. 16;

FIG. 20 shows the components that make up the slicing platform assembly of the slicer of FIG. 15;

FIG. 21a is an isometric top view of the slicing blade assembly of FIG. 20;

FIG. 21b is an isometric bottom view of the slicing blade assembly of FIG. 20;

FIG. 22 is a cross section of the slicing blade assembly taken through B-B of FIG. 21a;

FIG. 23 shows the blade removed from the slicing blade assembly of FIG. 21a;

FIG. 24 is an isometric bottom view of the assembled slicing platform of FIG. 20;

FIG. 25 is a section view through C-C of FIG. 24;

FIG. 26 is a section view through C-C of FIG. 24 with the blade rotated;

FIG. 27 is a close-up view of the blade drive of FIG. 24;

FIG. 28 is an isometric view of the base of the slicer of FIG. 15;

FIG. 29 shows the base and housing of the slicer of FIG. 15 prior to assembly;

FIG. 30 shows a first intermediate assembly step;

FIG. 31 shows a second intermediate assembly step;

FIG. 32 shows a third intermediate assembly step;

FIG. 33 shows the slicer in use with a loaded food product;

FIG. 34 shows the sliced food product of FIG. 33;

FIG. 35 illustrates an embodiment of a multiple slicer installation;

FIG. 36 illustrates a second embodiment of a multiple slicer installation;

FIGS. 37a and 37b show additional mounting configurations;

FIG. 38 is an input device for the slicer;

FIG. 39 shows a representative screen shot of the input device of FIG. 38;

FIG. 40 shows a second embodiment of a food item holder; and

FIG. 41 shows a third embodiment of a food item holder.

### DETAILED DESCRIPTION OF THE INVENTION

A slicer having a reciprocating blade is disclosed. The use of a reciprocating blade overcomes numerous shortcomings of the prior art. For example, a reciprocating blade allows the unit to be more compact. It also allows automatic stacking of the sliced product. It also dramatically simplifies the cleaning process. Another advantage of a reciprocating blade is that potential contaminants, such as food particles and liquids that are left behind when food is sliced, remain within the reciprocating range of motion. This is a back and forth motion, generally having a stroke of less than ½ of an inch.

For purposes of this disclosure, the term “food product” is defined as, but not limited to, a bulk portion of deli meats, cheeses, delicatessen products, delicatessen specialties, whole cut meats, processed meats and cheeses, sectioned and formed meats, cured meats and sausages packaged as chubs, rolls, loaves, wursts, with or without casings or any other packaging used to cook, cure, season, protect, present and transport the product. “Food product” is also defined as vegetable and produce such as tomatoes, lettuce, onions, peppers and any other vegetable, produce or sliced condiment.

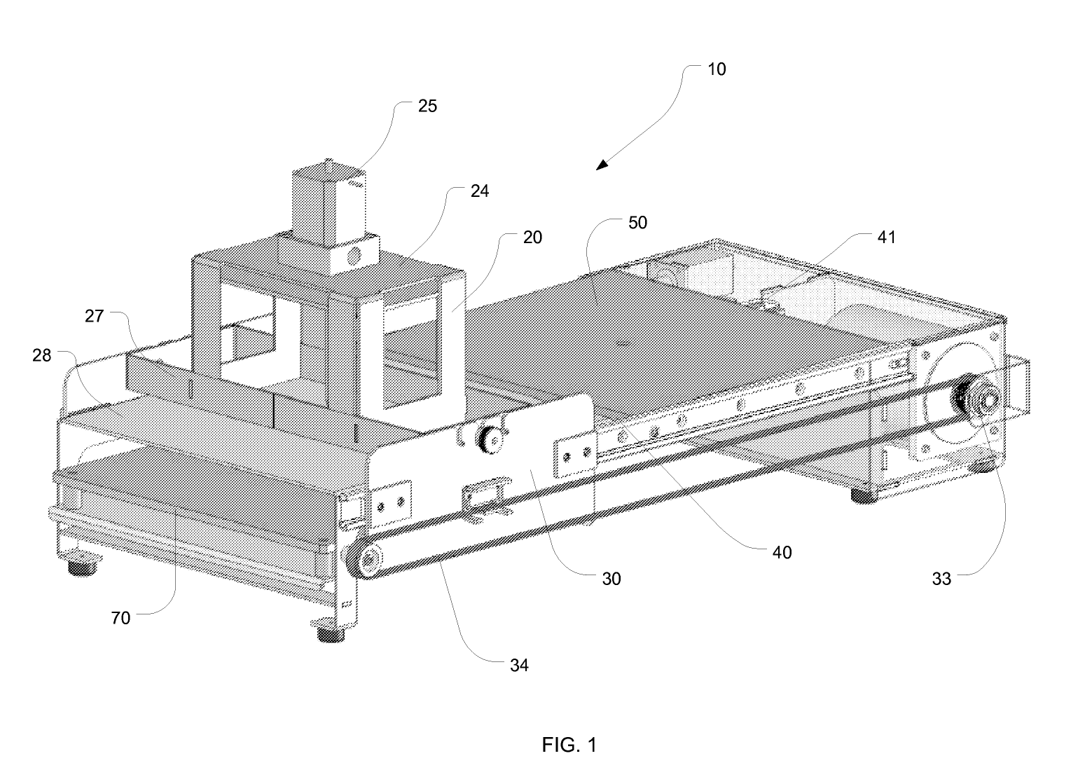

FIG. 1 shows a first view of a slicer according to the present invention. The slicer 10 includes a food product holder 20. In operation, the food product to be sliced is placed in the product holder 20. In some embodiments, a weighted top 24 is applied on top of the food product after it is placed in the product holder 20. In other embodiments, the top 24 includes a motor 25. This motor 25 is coupled to a vertical rod (not shown) ending in a horizontal plate, such that the motor 25 is able to extend and retract the rod and plate in the vertical direction, so that the horizontal plate applies a force to the food product. In other embodiments, a spring-loaded plate, an inflatable bag or diaphragm, or another method to apply downward force to the food product may be used. In other embodiments, no additional downward force is required.

The product holder 20 is of a size suitable for most food products, such as 5″×7″, but can be sized according to need. In other embodiments, the product is placed between two transverse members 27, where at least one of the members is adjustable, so as to match the width of the food product. These transverse members 27 are attached to the sliding carriage brackets 30.

The product holder 20 is coupled to sliding carriage brackets 30. As described below, the sliding carriage brackets 30 move in the horizontal direction from a first ready position, past the blade, to a completed position. The carriage brackets 30 then move back to the ready position.

Located adjacent to the carriage brackets 30 and product holder 20 is the reciprocating blade 40. In one embodiment, the blade 40 may be a single sharp edge, similar to a razor blade. In other embodiments, the blade 40 may be serrated, similar to a steak knife or jigsaw blade. The blade 40 reciprocates side to side in the horizontal direction, perpendicular to the direction of travel of the sliding brackets. In other embodiments, the blade can be at an angle to the product. As seen in FIG. 1, the carriage brackets 30 move from left to right, longitudinally along the slicer 10, while the blade 40 moves transversely across the slicer 10.

In some embodiments, a double edged blade is used which may perform one of two functions. The apparatus may contain a mechanism to flip the blade when one side becomes dull, thereby doubling the life of the blade. Alternatively, a mechanism may be provided to allow the blade to slice in both directions, thus doubling the slicing ability and speed of the apparatus.

The reciprocating blade 40 is adjacent to and located between a first platform 28 and a second platform 50. These platforms support the face of the food product as it is moved across the reciprocating blade 40. In some embodiments, a unitary platform with a slit to accommodate the reciprocating blade 40 may be used.

In operation, the food product is loaded into the product holder 20. In some embodiments, force is applied to the top of the food product after loading. This force may be applied in a variety of ways. The force can be applied using a passive device, such as a fixed weight atop the top 24, or a mechanical or pneumatic spring that pushes between the top of the product and the product holder. The force can alternatively be applied using an active device, such as a pneumatic or hydraulic cylinder, air bladder or the like that is supplied with pressure to exert a force. This can be a fixed pressure resulting in a fixed amount of added downward force, or the pressure can be increased as the product's weight decreases, resulting in a downward force that is consistent throughout the product. Other devices can include mechanical ratcheting devices that index a platen when the device is cycled for a slice. Positive displacement devices may be used to index a platen a predetermined distance as the product is sliced. One example of this is a screw actuator driven by a stepper motor 25. The motor 25 is able to drive a horizontal plate in the vertical direction. In these embodiments, the motor 25 is used to push the horizontal plate downward toward the food product so as to apply a force on the food product. In some embodiments, the motor 25 is configured to apply a force so that the total downward force exerted by the plate and the weight of the food product remains constant, even as the food product becomes smaller. In some embodiments, the motor is indexed a predetermined distance with each slice. For example, if the desired slice is .06 inches thick, the motor indexes the plate .06 inches, keeping the relationship between the food product and the blade consistent throughout. In some embodiments, the plate may index more or less than the slice thickness, for example, to compensate for weight changes, or other differences in the food product as it is consumed. Any of these methods serve to press the food product against the first platform 28 in the ready position.

One of the causes of inconsistent slicing is that food products, such as meat, cheese and other items being sliced are not rigid. Each food product has an inherent stiffness. In some embodiments, the face of the food product slides across the first platform 28 and into the reciprocating blade 40. The friction between the food product face and first platform 28 cause the food to displace rearward from the direction of travel and upward from the first platform 28. This presents a more compressed product to the blade 40 at the beginning of the slicing action than at the end. This can result in slice thickness differences on the order of 0.010 to 0.025 inches from the beginning to the end of the slice. In general, the thickness is controlled by changing the relative distance between the blade 40 and first platform 28. Over the course of many slices, the food product becomes wedge-shaped, which only adds to the inability to cut a consistent slice. In addition, this produces a “tail”, or thin appendage of the food product, on the trailing edge of the product. Neither of these conditions is desired.

The use of downward force may help to minimize this. Although the additional force adds to the friction, the downward force also pre-compresses and supports the food product. Additionally, the better the food product is supported around its perimeter, the more stable it may become, and the more consistently it slices. A combination of a low friction first platform 28 and a well supported food product greatly aid slicing consistency. In some embodiments, the downward force can be controlled and adjusted not only for the size of the food product, but also for the type of food product and its respective rigidity.

Additionally, the product holder 20 may contain means to rotate the food product as it is depleted (not shown). The food product can be rotated incrementally or rotated a full 180° with each rotation. The rotation can be performed after each slice, or after a predetermined number of slices. The rotation evens out the slice thickness inconsistency, substantially eliminating both the wedge and tail. The rotation may be accomplished by a number of methods. For example, the downward force means may include a motor or other device that rotates, thereby rotating the food product. In another example, there can be a strap-like device around the perimeter of the product that is turned by a capstan or other means.

The carriage brackets 30 are coupled to a motor 33, such as via a belt 34, chain or other linkage. A blade motor 41 is used to actuate the reciprocating blade 40. In some embodiments, the blade motor 41 rotates at a fixed rate, such that the reciprocating blade has a single speed, such as 1000 strokes per minute. In another embodiment, the blade motor 41 may rotate at a plurality of different speeds, such as between 500 and 2000 strokes per minute. The selection of the reciprocating speed may be done by the operator, or by a controller, as described in more detail below.

A thickness motor 37 (not shown) is used to set the appropriate slice thickness. This thickness motor is used to move the position of the reciprocating blade 40 and second platform 50 relative to the first platform 28, on which the food product rests prior to the slicing operation. This allows the thickness of a slice to be modified automatically by the controller. For example, in some embodiments, the thickness of a particular slice is set before slicing begins and remains constant throughout the cutting operation. In another embodiment, the thickness of the slice is varied as the blade 40 passes through the food product. This method may be used to adjust the thickness of the slice in real time. In other words, the distance between the first platform 28 and blade 40 is adjusted during the slicing process to compensate for the varying slice thickness from leading edge to trailing edge of the slice, resulting in a more even slice. Since food products have different stiffness, the amount of compensation may vary for any given product. Since the system is aware of the type of food product that is being sliced, a predetermined compensation factor may be used for each food product. In some embodiments, such as where there is no downward force applied or where it does not compensate for the changing weight of the food product, the thickness setting may be increased as the food product is consumed to compensate for diminishing compressive force. In other embodiments, the controller may move the blade 40 to a rest or inactive position between operations to minimize the chance of an operator cutting their finger.

The motor 33 drives the carriage brackets 30 toward and past the reciprocating blade 40, so that the reciprocating blade 40 passes entirely through the food product. The food product passes from the first platform 28, through the blade 40, and onto the second platform 50. After slicing, the carriage 30 returns to the ready position, returning the food product to the first platform 28, where it is ready for the next cycle. Attached to the sliding carriage brackets 30 is a collection platform 70, positioned at a height lower than the reciprocating blade 40. This collection platform 70 moves in unison with the sliding brackets 30 and food product, so that its position relative to the food product remains constant, even when the carriage brackets 30 are in motion. In other words, there is no relative linear movement between the food product and the collection tray 70 when the device 10 is cutting the food product. In other embodiments, the relative linear movement between the food product and the collection tray 70 is sufficiently small so as not to impact stacking of the sliced food product.

As the food product passes through the reciprocating blade 40, it begins to separate as a slice. The slice passes through the gap between the first platform 28 and blade 40, and is dropped downward onto the collection platform 70. The first slice touches down on the collection platform 70 at a first location. As the next slice is cut, it lands atop the previously cut slice. Since the collection platform retains its position relative to the food product, the result is a vertical stacking of the slices. The sliced food product can then be removed from the collection platform 70 and packaged for the customer.

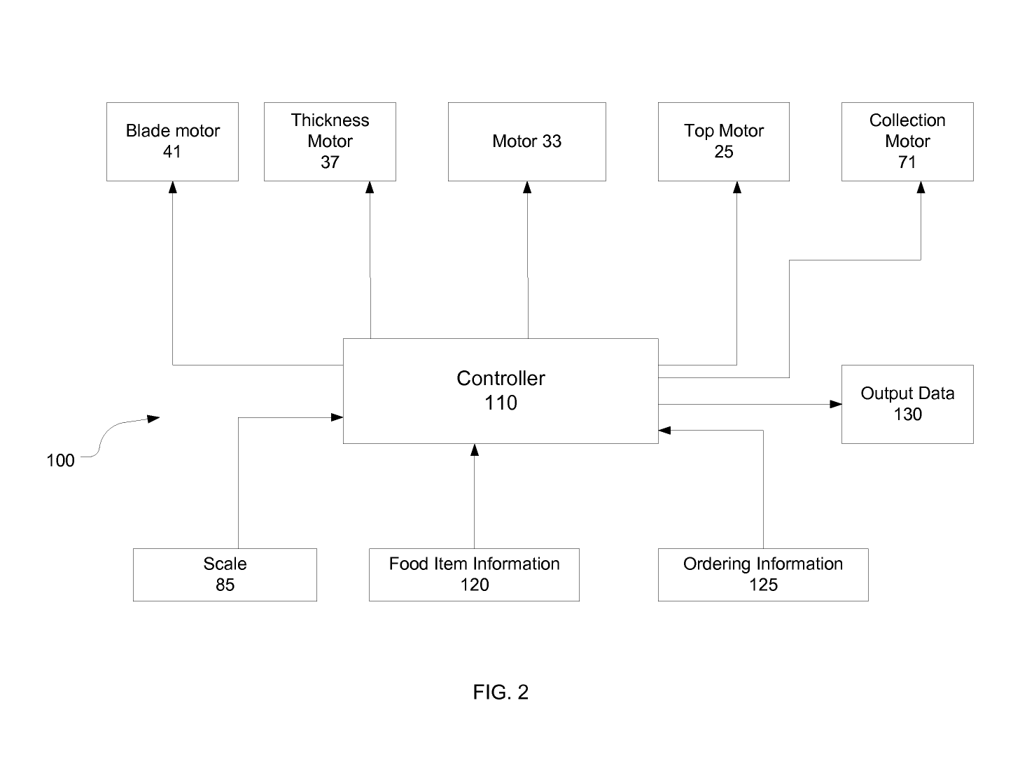

In some embodiments, the slicer 10 may include a control system that controls the operation of the system. FIG. 2 shows the major components of such a control system 100. It should be noted that not all of these components need to be present. This figure illustrates the flexibility of the control system, and embodiments are not limited to only that shown in FIG. 2.

A controller 110 is used to monitor and control the slicer 10. This controller 110 may be a stand alone computer, such as a personal computer (PC), a PLC or other logic controller or specially designed computing device. In other embodiments, the controller 110 is a part of the facility's central computer system. The controller 110 includes a processor, an input device capable of receiving commands and a plurality of outputs. In addition, the processing unit has a memory element, which may be volatile or non-volatile. Instructions that can be executed by the processor are stored in the memory element. The instructions executed by the processor may be written in any suitable computer language. These instructions, when executed, enable the controller 110 to perform the functions described herein. Furthermore, a portion of the memory element may be used for volatile information. A controller 110 may be used to control a single slicer 10, or may be used to control a plurality of slicers.

The controller 110 may receive food product information 120 from a variety of sources. This information may include the brand, food type, date of packaging, package dimensions, etc. This information may be input in a variety of ways. In one embodiment, a bar code reader is used to read a bar code from the food product itself. In another embodiment, an RFID reader is used to read an RFID tag located on the food product. In another embodiment, the operator may input the food product identifier, such as by using a keypad, or other input device. Other methods of informing the controller 110 of the identity and relevant information about the food product may also be used.

The controller 110 also receives ordering information 125. The ordering information can be entered by the operator using a keypad or other method. In another embodiment, the ordering information is collected by a separate processing unit, such as an electronic kiosk or similar system. The ordering information may include various parameters. For example, the ordering information may include a desired slice thickness and a desired amount. The desired thickness may be in quantitative terms, such as actual thickness measurements. In other embodiments, the thickness may be qualitative, such as very thin, thin, medium or thick. The controller 110 may then convert this qualitative thickness to an actual thickness based on the food product and other parameters. The thickness may also be expressed in non-traditional ways. For example, the slices may be cut based on the desired number of calories per slice, or the number of diet plan, for example, WEIGHT-WATCHER™, points per slice. The controller, knowing the food product type, can then determine the appropriate thickness to achieve the desired caloric or diet plan point total. The ordering information may also include an amount to be sliced. This can be expressed in numerous ways. For example, the user may indicate the number of slices, the total weight desired, the total number of calories desired, the total number of diet plan points, or any other quantitative way.

The controller 110 may also have input from a scale, thereby being aware of the weight of the sliced food product. In some embodiments, the scale 85 is integral with the collection platform 70, such that the weight of the sliced food product is updated as the food product is being sliced. In other embodiments, the weight of the food product is measured in the product holder 20, and the weight of the sliced food product is determined by subtracting the current weight of the remaining food product from its starting weight.

Other weighing methods are also envisioned. For example, in one embodiment, the entire slicer 10, including any loaded food product, may be weighed. One way to accomplish this is to include load cells, for example, in the feet of the slicer 10. The tare weight is the weight of the slicer 10 without a loaded food product. When a food product is placed onto the slicer 10, the weight of the food product is the new total weight less the tare weight. In this manner, the starting weight of the food product is known, eliminating the need to weigh the food product prior to loading it onto the slicer 10. If the collection platform 70 is not supported by the frame of the slicer 10, its contents will not be included in the total weight. Thus, as slices are removed from the food product, the total weight is reduced, the difference indicating the weight of the sliced food product. If greater accuracy is desired, the collection platform 70 may be mounted onto a weigh scale. In this manner, the total weight of the slicer 10, plus the loaded food product, plus the sliced product will be included in the total weight, and the weight of the sliced product only will be measured by the product tray scale. This gives the ability to accurately weigh the sliced food product, and also to know the weight of the remaining food product. Alternatively, if the weigh scale associated with the collection platform 70 is not supported by apparatus load cells, the weight of the sliced product is not included in the total. An advantage to knowing the total weight is that the weight of the remaining food product is always known. This information can be used to anticipate the need to replenish a food product, and to calculate yield, waste, etc., in real time. This information can be used to alert the operator that the weight of the currently loaded food product is below a predetermined threshold and that replacement will be required in the near future.

Using these inputs, the controller 110 is able to control the motors associated with the slicer 10. For example, after the food product has been loaded and the food product and ordering information have been entered, the controller 110 can begin the slicing process. The controller 110 may use the food information 120 to determine whether it should exert downward force on the food product in the product holder 20. For example, it may be found that a particular type of food product may require a predetermined downward force to insure a proper slice. In other embodiments, the downward force may be different, or unnecessary. Thus, based on the food product, the controller 110 may actuate top motor 25 to apply a downward force. Similarly, similar criteria may be used for distance indexing, as described above.

The controller 110 may also actuate the thickness motor 37. This adjustment may be based on the ordering information 125 and the food product information 120. In addition, the controller 110 may vary the thickness of a slice during the slicing process by actuating the thickness motor 37 while the blade 40 is cutting the food product. In addition, for safety and storage reasons, the controller 110 may automatically actuate the thickness motor 37 after the slicing operation is completed to minimize the chance of an injury. For example, the controller 110 may actuate the thickness motor 37 so as to move the blade to a stowed position, so it is not exposed, potentially causing injury. In one embodiment, the controller 110 actuates the motor 37 during each slicing operation, such that the blade is moved to the stowed position while the food product is returning to the first platform 28.

The controller 110 also controls the blade motor 41. In some embodiments, the controller 110 actuates the blade motor 41 at a fixed speed whenever a slicing operation is performed. In this instance, the controller 110 actuates the blade motor 41 and allows it to reach speed before actuating motor 33. In some embodiments, the controller 110 may maintain a table or other indication of blade speed as a function of food product. For example, certain food products may be better sliced if the blade is operating at high strokes per minute. Other food products may be better sliced at lower speeds. Therefore, based on the food product information 120, the controller 110 may actuate the blade motor 41 and select an appropriate speed for the blade 40.

The controller 110 also controls the motor 33, which causes the first platform 28 (and the food product) to move toward the reciprocating blade 40. This motor thereby controls the feed rate of the food product. The speed at which the food product slides may be a constant. In other embodiments, the speed may be related to the food product being sliced, or may be changed as the food product is consumed and puts less weight on the platform 28.

In some embodiments, the combination of blade speed and the feed rate is unique to each food product. In other embodiments, the blade speed may be varied while the feed rate remains constant. Conversely, the blade speed may be held constant, while the feed rate is varied.

The controller 110 also has the ability to produce certain output data 130. For example, in one embodiment, the controller 110 monitors the weight of the sliced food product as it is being sliced. Based on the change in weight during the slicing process, the controller 110 may determine the weight of each slice. As certain food products reach their ends (such as roast beef or turkey), the cross-sectional area of the food product decreases. This decrease in weight may be detected by the controller 110, which may interpret this as an indication that the food product is nearly consumed. In some embodiments, the controller 110 may also have the ability to track a particular food product, and be aware how much has been removed. This is another way that the controller 110 may determine when a food product is nearly consumed.

In some embodiments, the collection platform 70 may be an independently movable platform. In some embodiments, it may be desirable to create stacking patterns other than vertical. This can be achieved by offsetting the collection platform 70 after each slice. This offset may be achieved through the use of collection motor 71. This collection motor or motors 71 may move in any direction (up/down, forward/backward, left/right, rotate) in order to achieve the desired result. For example, at times it may be desirable to offset slices of a food product, such as cheese, 45° with respect to each other such that the corners of the pieces are separated. This can be done by using a collection motor 71 that rotates the collection platform 70 after each slice. Of course, other movements are also possible.

In some embodiments, the collection platform 70 is designated as a clean zone, in that it is never subjected to particles or other matter from the food product. In one embodiment, an optical sensor is used to detect the presence of a protective covering, such as a piece of waxed paper, a paper or foam tray, or other material. When such a covering is not detected on the collection platform 70, the controller 110 does not initiate a slicing action.

The controller 110 may receive continuous feedback from the scale 85. This feedback can be used in a number of ways. In one embodiment, the slicing operation is terminated when the scale 85 registers the total weight desired by the customer. The feedback from the scale 85 can also be used to determine when the food product is nearing its end, as described above. Other mechanisms can also be used to terminate the slicing process. For example, the customer may request a specific number of slices, which may be counted by the controller 110 during the slicing operation. When this number is reached, the slicing operation terminates.

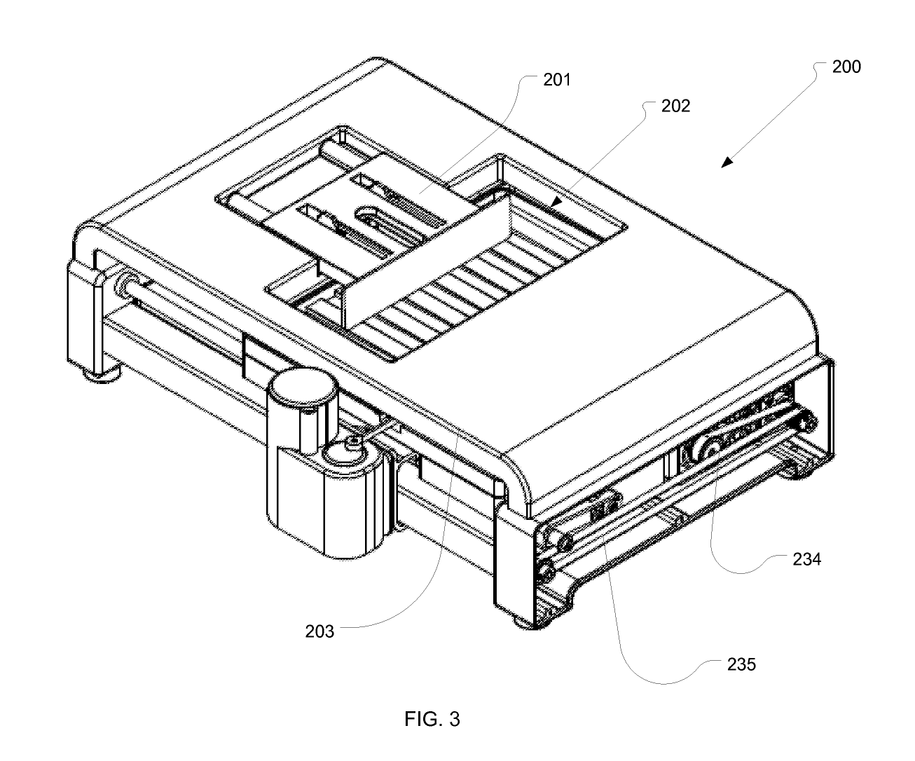

FIG. 1 shows a slicer where the food product moves while the reciprocating blade remains in a fixed location. FIG. 3 shows another embodiment, where the food product remains stationary and the reciprocating blade moves toward and away from the food product.

FIG. 3 shows a second embodiment of the slicer 200 having a reciprocating blade. In this embodiment, the food product is positioned on the top surface, and held in place using an adjustable product holder 201. The food product is placed in the opening 202 in the top cover 203. Once placed, it is held snugly in place by adjustment of the product holder 201. The food product remains in this position, as the blade moves from back and forth beneath it.

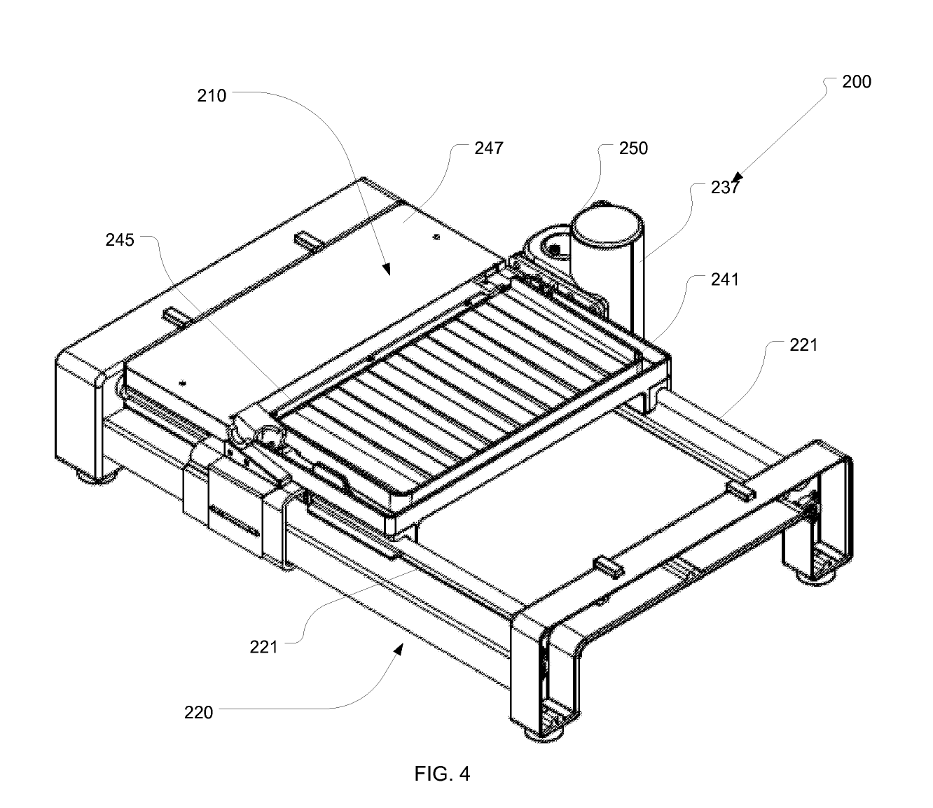

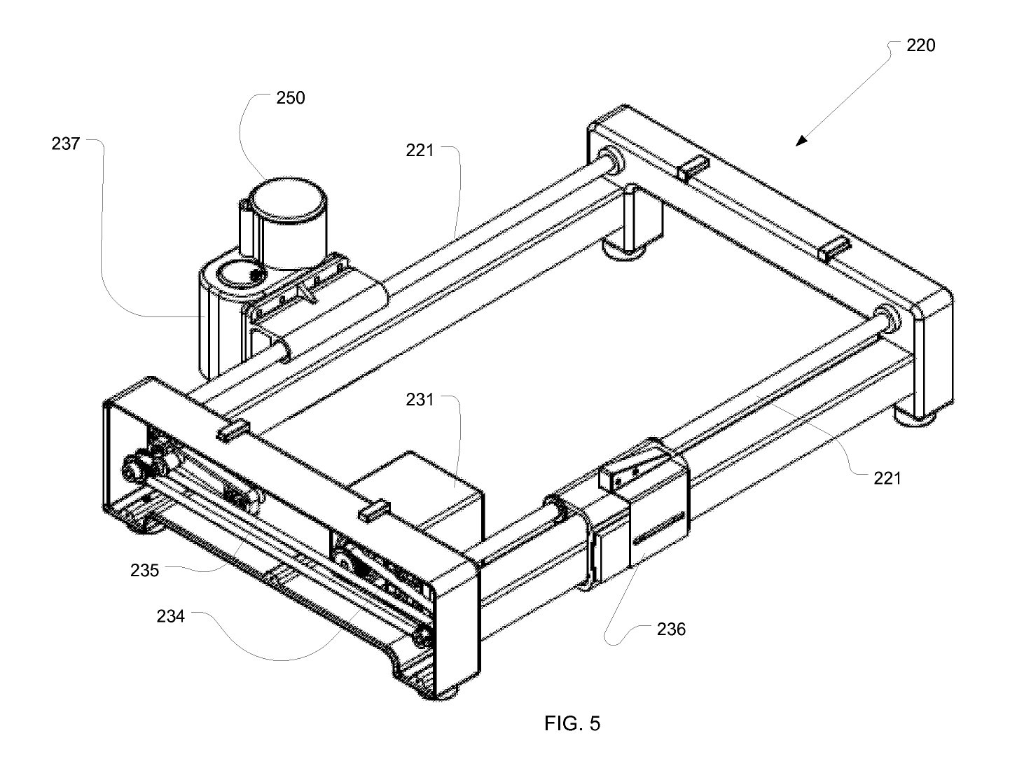

FIG. 4 is another view of the slicer 200 with top cover 203 removed. The slicer 200 has two major components, a bottom portion 220, which is shown in more detail in FIG. 5 and an upper portion 210, shown in more detail in FIG. 6.

Referring to FIGS. 4 and 5, the bottom portion 220 has two parallel synchronized acme screws 221. These screws 221 are rotated by the actuation of motor 231. As best seen in FIGS. 3 and 5, motor 231 is attached via belt 234 to one of the acme screws 221. A second belt 235 is used to couple the two screws so that they rotate in a synchronized manner. Located on each of the acme screws 221 is a drive carriage bracket 236,237. Within each of these brackets is an acme screw nut (not shown). As the acme screws 221 rotate, they cause the drive carriage brackets 236, 237 to move laterally.

Referring to FIGS. 4 and 6, the upper portion 210 includes a first platform 241, a blade 245, and a second platform 247. In the ready position, the food product rests on the first platform 241. The blade 245, the first platform 241, and the second platform 247 are attached to the drive carriage brackets 236, 237, such that they are moved laterally when the slicer 200 is in operation. As the carriage moves, the food product is held in place by the adjustable product holder 201. The food product then encounters the blade 245 that slices the food product from the bottom side. The food product then moves onto the second platform 247. As the carriage returns to its starting position, the food product returns to the first platform 241. The blade 245 is reciprocated by actuation of a blade motor 250, which is located on drive carriage bracket 237. The blade 245 is attached to the blade motor 250 through a linkage 251. In one embodiment, this linkage is a flexible coupling, such as a living hinge.

In the embodiment shown in FIGS. 3-6, the collection tray (not shown) is located beneath the lower portion 220 and may be stationary. As the drive carriage moves, slices drop onto the collection tray. In some embodiments, a collection tray motor may be used to translate the collection tray so as to create a desired pattern of slices. For example, the slices may be shingled or tiled, depending on a user's preference.

In addition, a thickness motor (not shown) may be used to set the thickness of the individual slices. In one embodiment, the thickness motor is used to move the first platform 241 vertically relative to the blade 245 and the second platform 247. In a second embodiment, the thickness motor is used to move the blade 245 and second platform 247 relative to the first platform 241. In another embodiment, the thickness motor moves the blade 245 relative to both platforms. Since the thickness motor is associated with the moving upper portion 210, it will preferably be located on the drive carriage bracket 236, 237. As was described above, the thickness motor may be used to set the thickness of a slice. In other embodiments, the thickness motor may be actuated during the slicing process to alter the thickness of a slice. In other embodiments, the thickness motor may also be stationary, attached to the end of lower portion 220 and may use a shaped rod that passes thru a similarly shaped linear bearing on a screw attached to drive carriage 236 that adjusts the thickness ramp position.

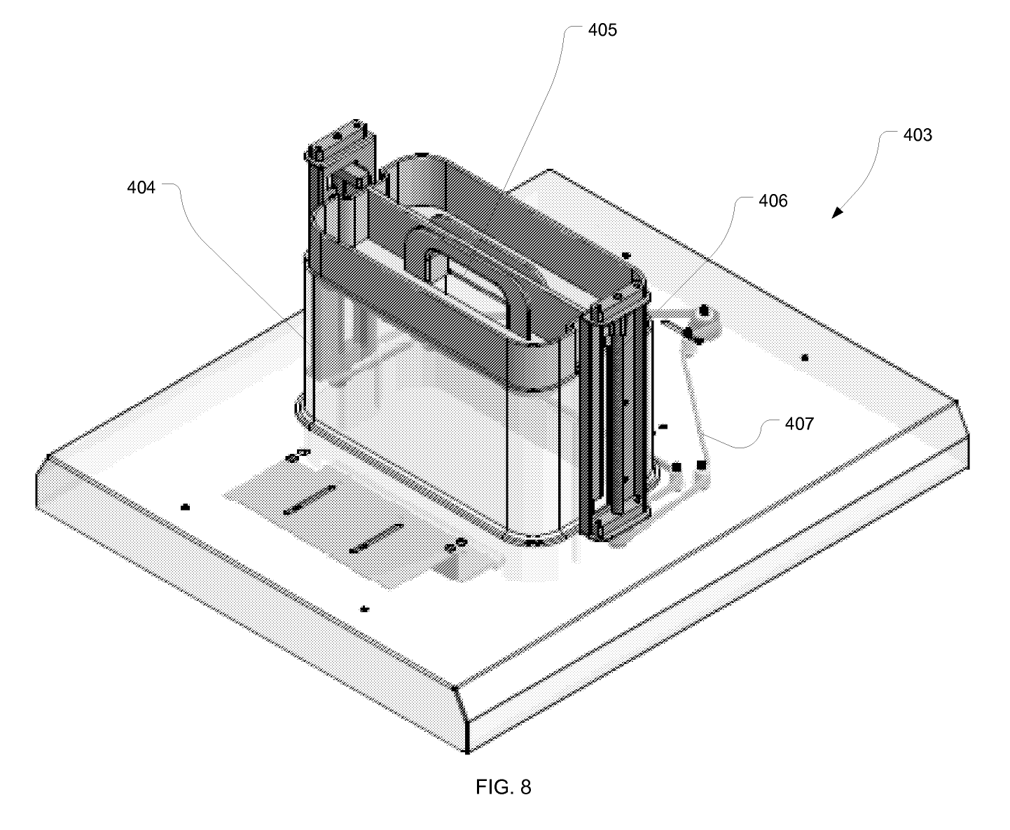

FIG. 8 shows an alternate top cover 403 that can be used with the slicer 200 described in FIGS. 4-7. In this embodiment, the top cover 403 has an integrated product holder 404. The product holder 404 includes a lid 405, which may be coupled to rotatable screws 406 on opposite sides of the product holder 404. In this embodiment, rotation of screws 406 causes a corresponding upward or downward movement of the lid 405. In operation, the food product is inserted into the integrated product holder 404. The lid 405 is then placed over the food product and moved downward toward the food product. In some embodiments, the lid 405 is not engaged with the screws 406 until the operator initiates this action.

In some embodiments, the operator presses the lid 405 onto the food product and then engages the screws 406 to keep the lid pressed against the food product.

In other embodiments, the operator engages the screws, which then rotate to lower the lid 405 toward the food product. In some embodiments, a load cell (not shown) or other force measuring device is used to measure the compression force being applied by the lid 405 to the food product. This data, in conjunction with the type of food product, can be used to compress the food product with a desired force. For example, food products with high water content may need to be compressed more than other food products, such as cheeses. By having visibility to the food product type and the force being applied, the slicer 200 can be configured to exert a unique predetermined force on each type of food product.

In other embodiments, the screws 406 rotate until the lid 405 touches the food product. This can be determined using a proximity sensor, such as a capacitive sensor, and measuring an increase in force needed to rotate the screws 406. Once this point of contact is established, the controller may optionally stop the rotation of the screws 406. In another embodiment, the controller may continue to rotate the screws 406 so that the lid 405 moves downward by a predetermined distance. This distance may be related to the type of food product in the product holder 404.

The screws 406 may be coupled to a motor (not shown) via a linkage 407. Linear motions of the linkage 407 causes rotational movement of the screws 406. In some embodiments, the movement of the screws 406 is a function of the desired compression force. In other words, when a slice of the food product is removed, the screws 406 rotate so as to maintain the same compression force.

In other embodiments, the movement of the screws may be correlated to the thickness of the slice. In other words, when a slice is removed, the screws rotate such that the lid 405 moves downward by a distance equal to the thickness of the removed slice. Other methods can also be used to control the movement of the lid 405.

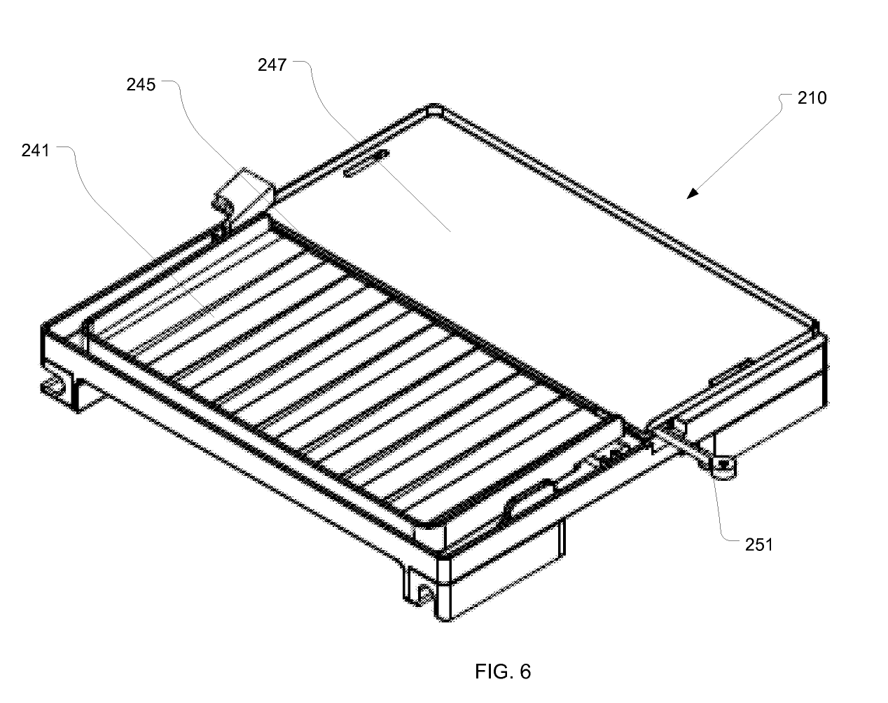

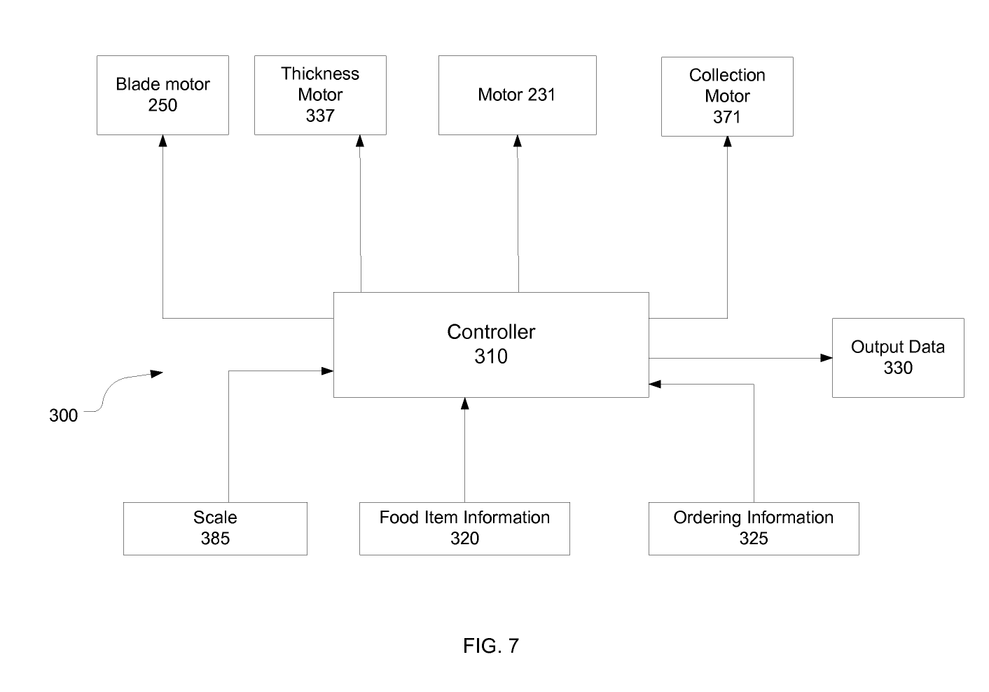

As described above, a control system may be used to control this slicer. FIG. 7 shows the major components of such a control system 300. It should be noted that not all of these components need to be present. This figure illustrates the flexibility of the control system and embodiments are not limited to only that shown in FIG. 7.

A controller 310 is used to monitor and control the slicer of FIGS. 3-6. This controller 310 may be a stand alone computer, such as a personal computer (PC) or specially designed computing device. In other embodiments, the controller 310 is a part of the facility's central computer system. The controller 310 includes a processor, an input device capable of receiving commands and a plurality of outputs. In addition, the processing unit has a memory element, which may be volatile or non-volatile. Instructions that can be executed by the processor are stored in the memory element. The instructions executed by the processor may be written in any suitable computer language. These instructions, when executed, allow the controller 310 to perform the functions described herein. Furthermore, a portion of the memory element may be used for volatile information. The controller 310 may be used to control one slicer 200 or a plurality of slicers.

The controller 310 may receive food product information 320 from a variety of sources. This information may include the brand, food type, date of packaging, package dimensions, etc. This information may be input in a variety of ways. In one embodiment, a bar code reader is used to read a bar code from the food product itself. In another embodiment, an RFID reader is used to read an RFID tag located on the food product. In another embodiment, the operator may input the food product, such as using a keypad, or other input device. Other methods of informing the controller 310 of the identity and relevant information about the food product may also be used.

The controller 310 also receives ordering information 325. The ordering information can be entered by the operator using a keypad or other method. In another embodiment, the ordering information is collected by a separate processing unit, such as an electronic kiosk or similar system. The ordering information may include various parameters. For example, the ordering information may include a desired slice thickness and a desired amount. The desired thickness may be in quantitative terms, such as actual thickness measurements. In other embodiments, the thickness may be qualitative, such as very thin, thin, medium or thick. The controller 310 may then convert this qualitative thickness to an actual thickness based on the food product and other parameters. The thickness may also be expressed in non-traditional ways. For example, the slices may be cut based on the desired number of calories per slice, or the number of diet plan points per slice. The controller, knowing the food type, can then determine the appropriate thickness to achieve the desired caloric or diet plan point total. The ordering information may also include an amount to be sliced. This can be expressed in numerous ways. For example, the user may indicate the number of slices, the total weight desired, the total number of calories desired, the total number of diet plan points, or any other way.

The controller 310 may also have input from a scale, thereby being aware of the weight of the sliced food product. In some embodiments, the scale 385 is integral with the collection tray, such that the weight of the sliced food product is updated as the food product is being sliced.

Using these inputs, the controller 310 is able to control the motors associated with the slicer of FIG. 3. For example, after the food product has been loaded and the food product and ordering information have been entered, the controller 310 can begin the slicing process.

The controller 310 may also actuate the thickness motor 337. This adjustment may be based on the ordering information 325 and the food item information 320. In addition, the controller 310 may vary the thickness of a slice during the slicing process by actuating the thickness motor 337 while the blade 245 is cutting the food product. In addition, for safety and storage reasons, the controller 310 may automatically actuate the thickness motor 337 after the slicing operation is completed to minimize the chance of an injury.

The controller 310 also controls the blade motor 250. In some embodiments, the controller 310 actuates the blade motor 250 at a fixed speed whenever a slicing operation is performed. In this instance, the controller 310 actuates the blade motor 250 and allows it to reach speed before actuating motor 250. In some embodiments, the controller 310 may maintain a table or other indication of blade speed as a function of food product. For example, certain food products may be better sliced if the blade is operating at high strokes per minute. Other food products may be better sliced at lower speeds. Therefore, based on the food product information 320, the controller 310 may actuate the blade motor 250 and select an appropriate speed for the blade 245.

The controller 310 also controls the motor 231, which causes the reciprocating blade 245 to move through the food product. The speed at which the drive carriage slides may be a constant. In other embodiments, the speed may be related to the food product being sliced.

The controller 310 also has the ability to produce certain output data 330. For example, in one embodiment, the controller 310 monitors the weight of the sliced food product as it is being sliced. Based on the change in weight during the slicing process, the controller 310 may determine the weight of each slice. As certain food products reach their ends (such as roast beef or turkey), the cross-sectional area of the food product decreases. This decrease in weight may be detected by the controller 310, which may interpret this as an indication that the food product is nearly consumed.

In some embodiments, the collection tray may be an independently movable platform. In some embodiments, it may be desirable to create other stacking patterns. This can be achieved by offsetting the collection tray after each slice. This offset may be achieved through the use of another collection motor 371. This collection motor or motors 371 may move in any direction (up/down, forward/backward, left/right, rotate) in order to achieve the desired result. For example, at times it may be desirable to offset slices of cheese 45° with respect to each other such that the corners of the pieces are separated. This can be done by using a collection motor 371 that rotates the collection tray after each slice. Of source, other movements are also possible.

The controller 310 receives continuous feedback from the scale 385. This feedback can be used in a number of ways. In one embodiment, the slicing operation is terminated when the scale registers the total weight desired by the customer. The feedback from the scale can also be used to determine when the food product is nearing its end, as described above. Other mechanisms can also be used to terminate the slicing process. For example, the customer may request a specific number of slices, which may be counted by the controller 310 during the slicing operation. When this number is reached, the slicing operation terminates.

In some embodiments, the controller 310 may interface with a second scale, which weighs, either directly or indirectly, the weight of the remaining loaded, but unsliced food product. Several methods of determining the weight of the loaded food product are described herein. This information can be used to alert the operator that the weight of the currently loaded food product is below a predetermined threshold and that replacement will be required in the near future.

As is obvious from this description, this new slicer is able to operate unattended. In conventional slicers, an operator needs to manually move the tray holding the food product through the rotary blade with one hand. The operator typically uses their other hand to catch the sliced food product as it is cut by the blade. The present slicer is able to slice, stack and weigh the food product without operator intervention. With a conventional slicer, the operator must use their hand to stack the slices, even if the slicer has an automated carriage. One of the major advantages of this invention is automated stacking, allowing truly unattended operation. Automatic stacking works because the collection tray retains its position relative to the food product being sliced. In the first embodiment, the product moves across the blade, and the collection tray moves in unison below it. This simulates an operator's hand moving with and below the product while using a conventional rotary slicer. In the embodiment of FIG. 3, the collection tray does not need to move and remains stationary under the stationary food product. With a conventional slicer, the food product moves across the blade, but the collection tray is stationary.

Stacking performance may also be influenced by the vertical distance between the slicing platform (i.e. the blade) and the collection tray. In particular, if the distance is too large, the slice of food product may fold over on itself rather that lay flat, thereby ruining the stack. The precise distance at which stacking is impaired depends upon both the thickness of the slice and the inherent firmness of the food product, but is generally in the range of 3 to 4 inches. Below this threshold, acceptable stacking is accomplished. If this distance becomes too small, it limits the height of the stack of sliced product, which limits the order size. In one embodiment, a distance of 1½ to 2 inches is small enough to assure that acceptable stacking occurs, and is large enough to accommodate orders of a pound or more. Alternatively, an automatic vertical adjustment, such as may be done by collection motor 371 (or another motor), may be included to maintain a predetermined distance between the slicing platform and the collection tray, and accommodate higher stacking.

In addition, the present slicer simplifies the cleaning process. Referring to FIGS. 3-6, the slicer can be divided into several zones. The first zone, or Zone 1, refers to those components that are in contact with the food product. These components are all part of the upper portion 210, shown in FIG. 6, and the product holder. Note that the upper portion (i.e. Zone 1) includes the first platform 241, the blade 245 and the second platform 247. Conveniently, these components are easily removed from the acme screws 221, as these components simply rest on the screws. The second zone, or Zone 2, refers to those components which never contact the food products. These include all of the components in the lower portion 220, shown in FIG. 5. A third zone, or Zone 3, includes those components which are separated from the food product by a piece of paper or plastic. This zone includes the collection tray, where the sliced food product is dropped. In some embodiments, this third zone is considered to be part of Zone 2.

In addition to simplifying cleaning, this configuration also eliminates the possibility of cross-contamination of food products, if desired. In this disclosure, cross-contamination is defined as the contact of a component, which was in direct contact with a first food product, with a second food product without cleaning. Such cross-contamination occurs everyday with today's slicers, as operators do not clean the slicer after each food product. However, the ease of replacement of Zone 1 components allows the elimination of cross-contamination. In one embodiment, a set of Zone 1 components is dedicated to a particular food product (such as BOAR'S HEAD™ Roast Beef), or group of food products (such as all Roast Beef). The Zone 1 components are readily interchangeable and include mostly plastic components, thereby making the cost of this set of components rather low.

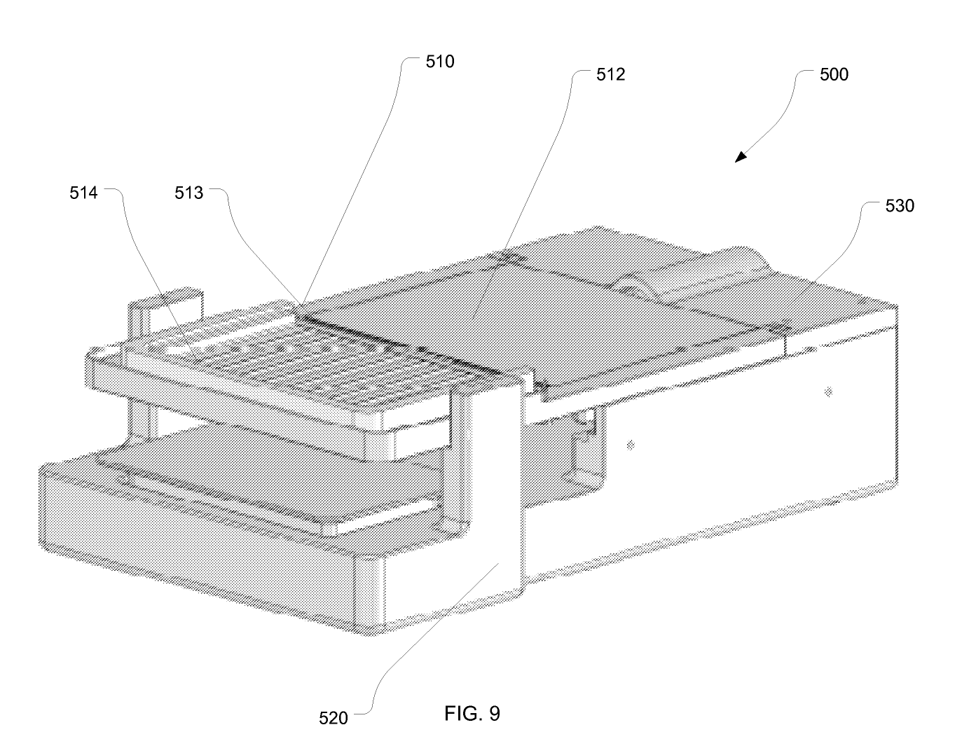

FIG. 9 shows another embodiment of a slicing apparatus. In this embodiment, like that shown in FIG. 3, the food product remains stationary while the blade is moved through it. This embodiment is designed in such a way so as to minimize the number of linkages. As shown in FIG. 9, the slicing apparatus 500 includes a removable, slidable tray 510 which has a first platform 512, a blade 513, and a second platform 514. The tray 510 rests on a base 520. Abutting or coupled to the tray 510, is a motor assembly 530. The motor assembly 530, as will be described in more detail below, moves back and forth along rails located in the base 520, which propels the tray 510.

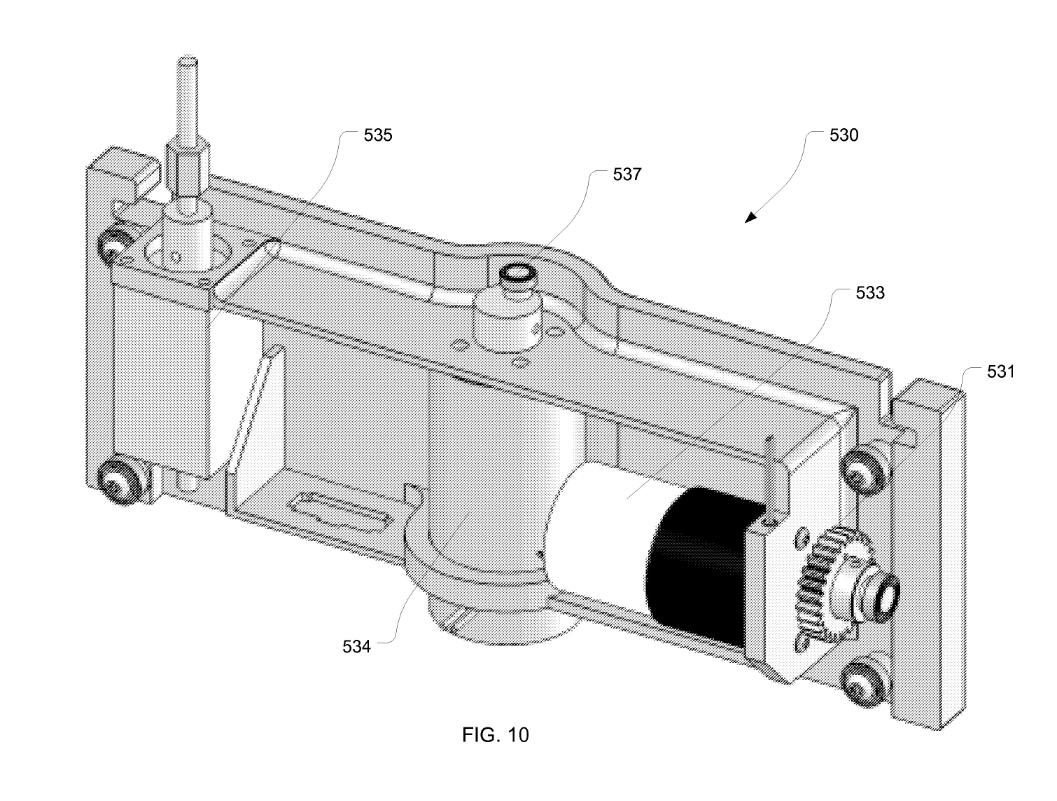

As shown in FIG. 10, the motor assembly 530 includes several motors, such as but not limited to a main motor 533, which causes the rotation of a toothed gear 531 which rests in a corresponding groove in the rail of the base 520. As the motor turns in a first direction, the motor assembly 530 is urged forward. As the motor 533 turns in the opposite direction, the motor assembly 530 is urged backward. As the motor assembly 530 is coupled to the removable tray 510, the removable tray 510 follows this motion as well. The motor assembly 530 also includes a blade motor 534, which serves to cause the blade 513 to reciprocate. The blade motor 534 may include an eccentric 537. A third motor 535 is used to control the height of the blade 513. In some embodiments, the electrical connections for these three motors 533, 534, 535, are bundled together in a single cable (not shown).

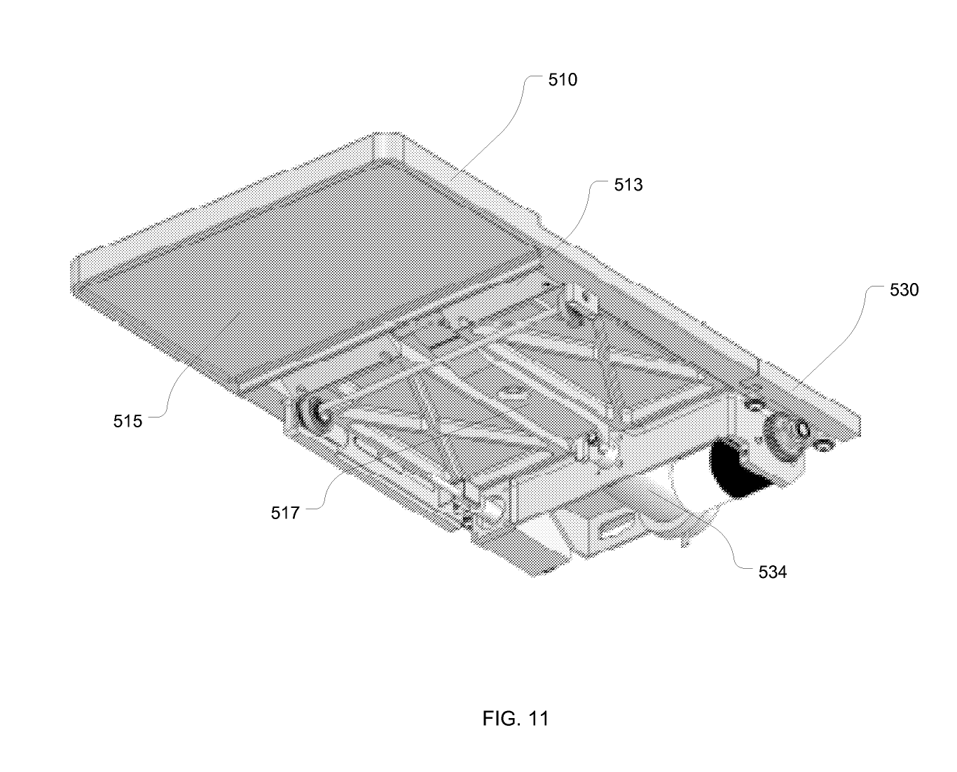

FIG. 11 shows the underside of the tray 510 and the motor assembly 530. The blade 513 is coupled to a linkage 517, which in turn is coupled to the motor 534. Rotation of motor 534 causes the movement of the eccentric 537, which causes an oscillating motion of the linkage 517, which in turn causes the blade 513 to reciprocate.

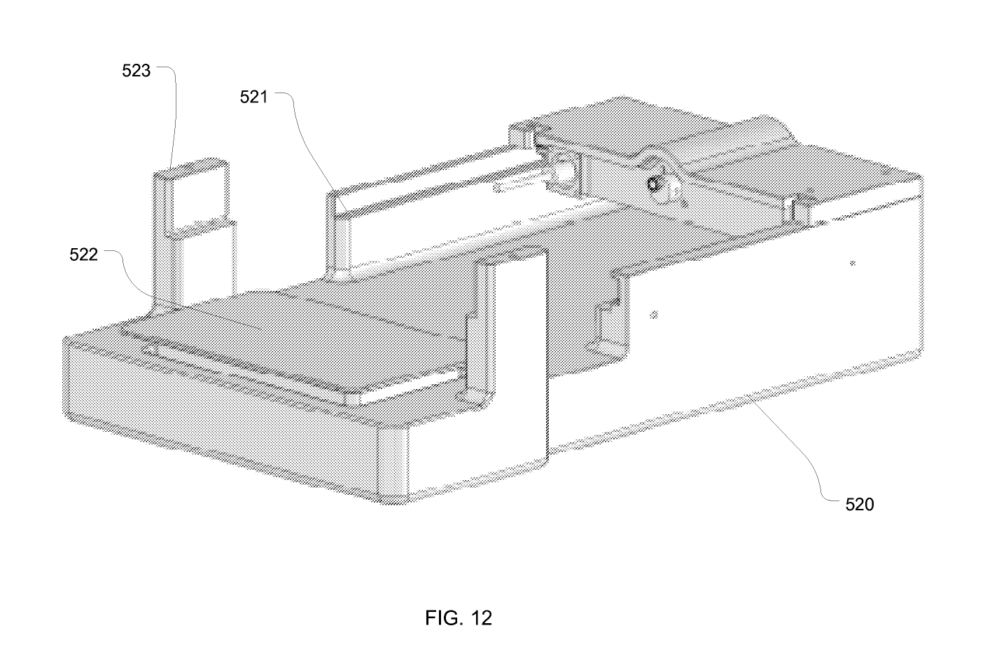

FIG. 12 shows the base 520 without the tray 510 installed. The tray 520 includes rails 521 on which the tray 510 rests and slides. The base 520 also includes a collection tray 522, which may be removable. In some embodiments, the collection tray 522 also includes a weight measurement device, so that the collection tray can weigh the food item that has been sliced. The base 520 also includes a holding mechanism 523, which is used to hold the food item in place. In this embodiment, the tray 510 slides along the rails 521, bringing the blade 513 into contact with the food item, which remains stationary throughout the cutting operation.

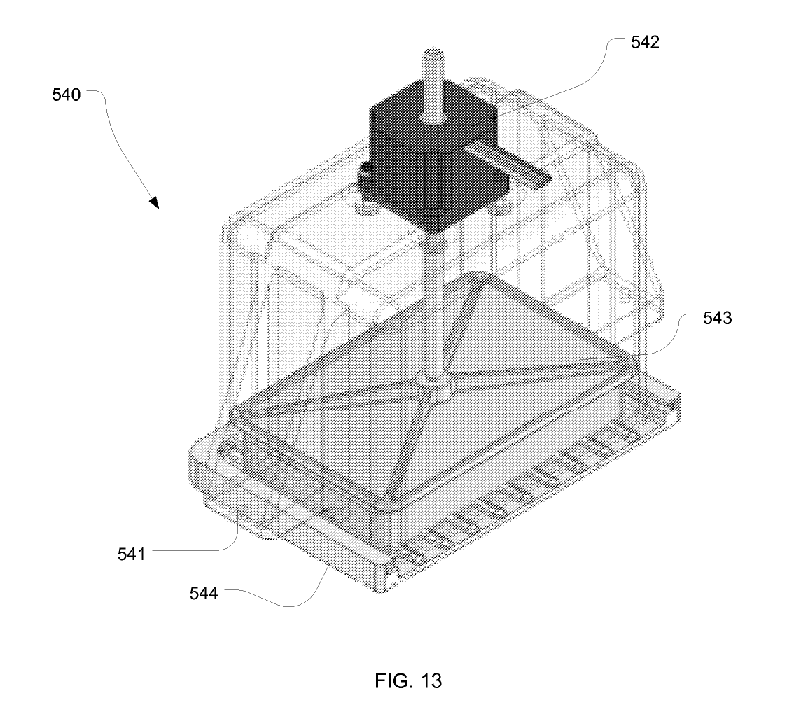

The food item is held in place by a food item holder 540, shown in FIG. 13. In some embodiments, a fastening mechanism 541 is included on the food item holder 540, which couples to the holding mechanism 523 on the base 520. This fastening mechanism 541 may be thumbscrews or any other fastening means known in the art. In some embodiments, the food item holder 540 includes a motor 542, which actuates a platen 543. This platen 543 is used to urge the food item toward the base 520. In some embodiments, after initial setup, the motor 542 actuates the platen 543 to cause it to move downward by the distance equal to the thickness of the slice being cut. Thus, the pressure or downward force on the food item remains roughly constant through the slicing operation.

In some embodiments, the food item holder 540 includes a slidable front face 544. The front face 544 is opposite the platen 543 and acts to support the food item between these two surfaces. In this embodiment, the removable tray 510 includes a hollow or recess portion 515 (see FIG. 11) in the second platform 514. The front face 544 fits into this recess 515. When the tray 510 is moved by the motor assembly 520, the front face 544 moves with the second platform 514, thereby exposing the food item to the blade 513. The food item is held stationary by the food item holder 540, which, as described above, is held in place on the base 520.

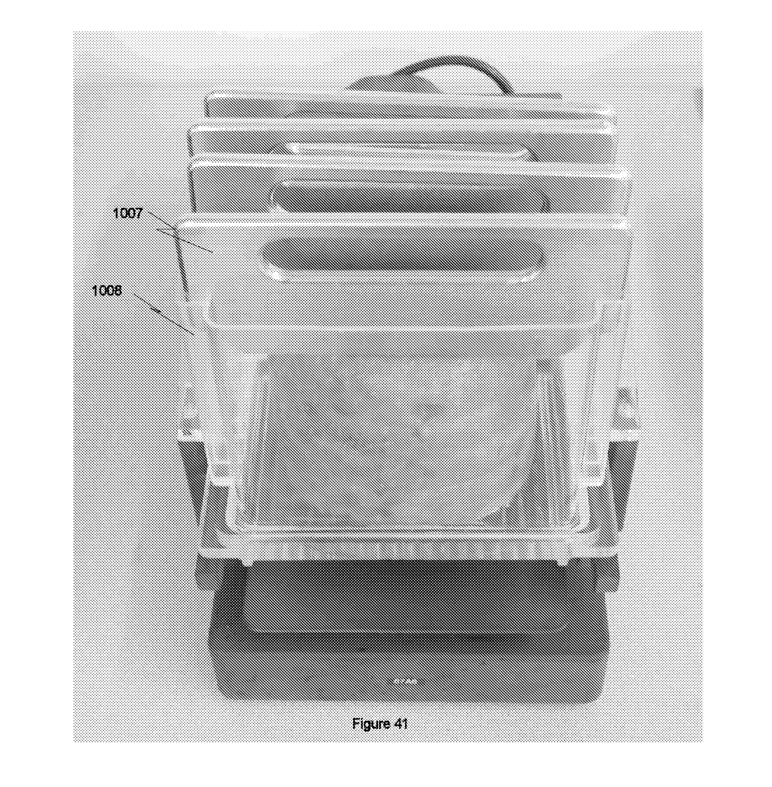

FIG. 40 shows an alternative embodiment of a food item holder 1000. Near the top is a movable platen 1001. The platen 1001 contains one or more drive motors (not shown), each connected to a drive shaft. On the end of each drive motor shaft is a gear 1002. In some embodiments, there is a gear 1002 on each end of the platen 1001. The gear 1002 meshes with a gear rack 1003 that is part of the food item holder 1000. In a preferred embodiment, this rack 1003 is molded into the holder 1000. Once the food item is placed into the holder 1000, the platen 1001 is put into position as shown. To advance the platen 1001 and put force onto the food product, the motors are driven, rotating the gears 1002 and thereby driving the platen 1001 downward as the gears 1002 move along the rack 1003. The motors of this embodiment are contained and sealed within the platen 1001 and so are not exposed. This embodiment also lowers the profile of the food holder as compared with that in FIG. 13, since there is no drive shaft extending above the holder.

The platen 1001 may also comprise an integrated handle 1004 to assist with installing the platen 1001 when a food item is loaded, and for carrying the loaded food holder. Also seen in FIG. 40 is a food item pusher 1005. This can be a spring loaded device with a pusher bar 1006, used to bias the food product against the front of the holder 1000, aiding in stabilizing the product during slicing. Other biasing mechanisms may also be used.

In another embodiment, a passive mechanism is employed, which utilizes a one-way device that allows the platen to descend as the food product is consumed, but does not allow it to rise. This can be accomplished by a gear and rack system as in the above embodiment. The drive motors are removed and replaced by a one-way clutch or similar device known in the art. The platen can be weighted as desired to apply a force to the food item. When a slice is removed, the weighted platen lowers, taking up the removed space. The one-way device prevents the platen from going back up and stabilizes the food item for the next slice. Any one-way device can be used, such as a ratcheting device with a pawl and gear, or another device known in the art.

FIG. 41 shows an alternative passive mechanism that can be used to apply force on the food item. It utilizes one or more manually installed weights 1007. These weights 1007 fit slidably into slots 1008 in the food product holder. The embodiment shown in FIG. 41 has four weights, although other numbers of weights may be used. The use of multiple weights holds the food item across its uneven top surface and aids in stabilizing the product during slicing as well as applying force to the product. The quantity and mass of the weights can be tailored to the size of the slicing apparatus and weight of the food products that are to be sliced. The embodiment shown in FIG. 41 uses four stainless steel weights of two pounds each, for a total of eight pounds.

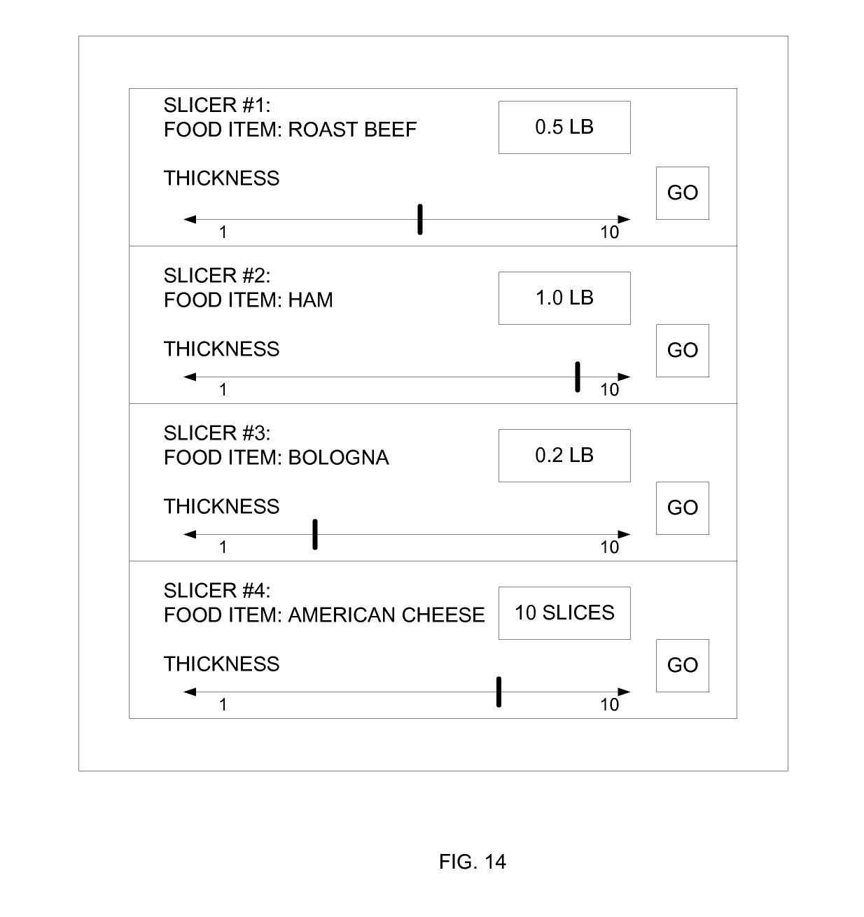

In some embodiments, one or more slicers can be controlled by a software application. This software application may be written in any suitable programming language and may execute on any suitable computing device, such as but not limited to a personal computer (PC), a handheld computing device, such as a tablet, a smartphone, or any other device. FIG. 14 shows a representative user interface that can be used in conjunction with one or more slicers. In some embodiments, the application is executed on a device having a touchscreen to simplify the user interface. In this embodiment, four slicers are shown, however, the application may include more or fewer slicers as required.

The application shown in FIG. 14 shows 4 subsections, one dedicated to each slicer. In this embodiment, the information that the operator can enter is limited to thickness and weight or slice count. In other embodiments, additional input may be permitted. Each subsection shows the slicer number, and the article loaded on that slicer. In some embodiments, the operator enters the food item that is loaded on the slicer. In other embodiments, there is a scanner or bar code reader at the slicer that reads an indicia from the packaging of the food item and relays that information to the software application.

Communication between the slicer and the software application may be wired, such as by USB or Ethernet, or may be wireless, such as by Bluetooth, IR, Zigbee, WIFI, or any other wireless protocol. Communication with the slicer may be bidirectional. For example, the software application may instruct the slicer on what and how to slice food product, and the slicer may return information to the software such as remaining food product, operating condition of the slicer, etc. This information can be used to instruct an associate to replace a consumed, or nearly consumed, food product with a new one, inform the system of the amount of food product remaining at the end of slicing, issue an alert pertaining to a slicer failure, maintenance need, etc. This information can be used to insure consistent operation of the slicers, as well as data reporting and calculations such as yield, efficiency, etc.

This communication system allows one or more slicers to receive instructions from multiple input sources. The software can include a queue management system to organize and control orders from all inputs.

The software application also allows the operator to input the desired thickness of the slice. In this embodiment, the thickness is shown as a sliding scale from 1 to 10. In other embodiments, the operator may input actual thicknesses, such as in 1/16 inch increments. The operator also enters the desired quantity of the food item. In one embodiment, shown in the upper subsections, the quantity is expressed in terms of weight. In other embodiments, such as in the lower subsection, the quantity is expressed in number of slices. Other measures of quantity, such as calories or Weight Watcher points, may also be used if desired.

Once the operator has entered this information, the “GO” tab is pressed. This action transmits the quantity and thickness information to the designated slicer. The remote slicer then initiates the slicing operation. In some embodiments, the slicer may respond to the software application, such as indicating that the desired operation has been successfully completed or has failed.

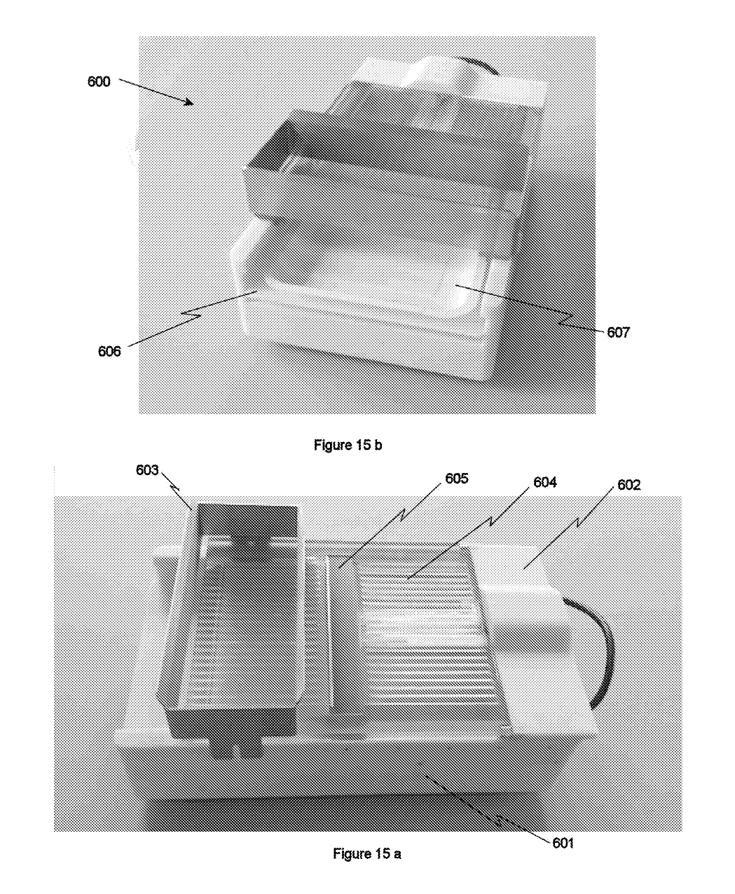

FIGS. 15a and 15b show another embodiment of a slicer 600. A housing 601 covers the base (not visible) and provides mounting and bearing surfaces for other components. The drive unit 602 contains the motors, components and wiring necessary to drive the slicing platform, reciprocate the blade and adjust the slice thickness, similar to that described in FIG. 10. The food product holder 603 accepts and holds the food product for slicing. In this embodiment, force is not applied on top of the food product. This allows the slicer 600 to slice and use virtually the entire food product. The slicing platform assembly 604 contains the blade assembly 605 and is translated when driven by the drive unit. The weigh scale cover 606 and a food collection tray 607 are also shown.

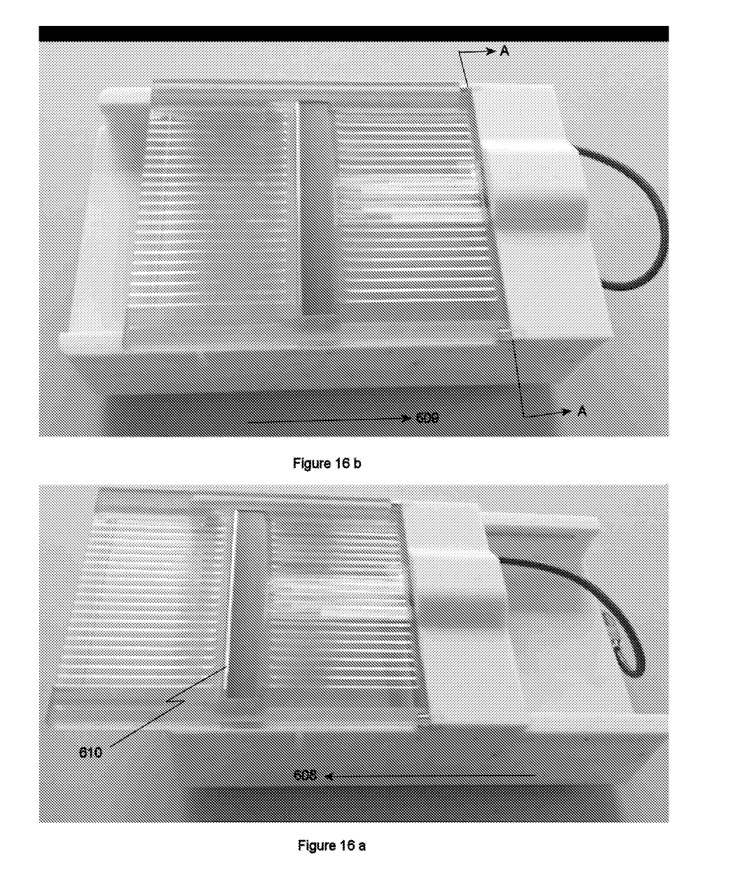

In this embodiment, the food product remains in a fixed location and the slicing platform 604 and blade 610 move beneath the food product to slice it. FIGS. 16a and 16b illustrate the limits of movement of the slicing platform 604 and drive unit. In FIG. 16a, the slicing platform 604 has been driven to the leftmost limit 608. In this position, the leading edge of the blade 610 has moved far enough to be past the food product and will have separated a slice. FIG. 16b shows the drive unit and slicing platform returned to their home position 609, which is the rightmost limit.

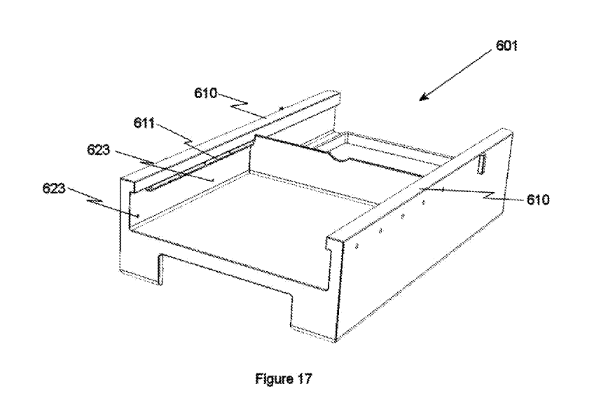

FIG. 17 shows a view of the housing 601. This housing may be made from a food-grade plastic material or a metal, such as stainless steel. The uppermost surfaces 610 are bearing surfaces on which the drive unit 602 and slicing platform 604 slide. Beneath these surfaces are two gear racks 611, one on either side (only one is visible). These racks 611 are used by the drive unit 602 to propel itself and the slicing platform 604 between the positions shown in FIGS. 16a-b.

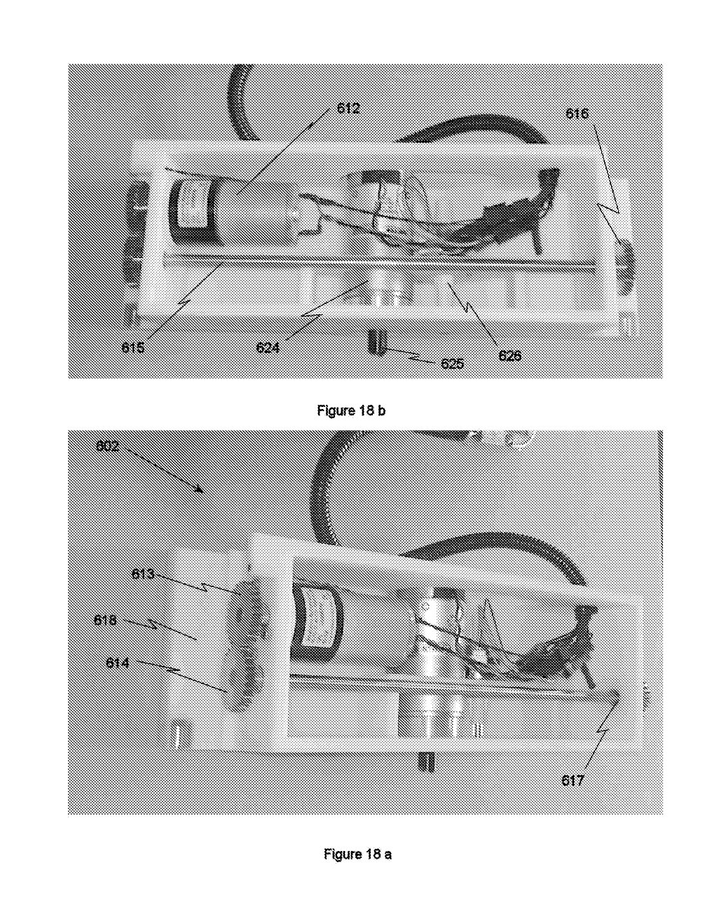

FIGS. 18a and 18b are bottom views of the internal components of the drive unit 602. The slicer platform drive motor 612 is mounted to the side wall of the drive unit 602 as shown. The motor shaft passes through the wall and has a gear 613 mounted on its end. One suitable motor is a DC permanent magnet motor, part number BDSG-37-40-12V-5000-R100, supplied by Anaheim Automation of Anaheim, Calif., although other motors may be used. The drive gear 613 can be of any suitable size and material as known in the art. The gear 613 shown is a 24 pitch with 26 teeth. This gear 613 meshes with a driven gear 614 that is mounted to a shaft 615 with another driven gear 616 mounted on the opposite end. The shaft 615 is supported by bearings 617 in the drive unit wall. The surface 618 on both ends of the drive unit 602 are bearing surfaces that slide on the housing's bearing surface 610, shown in FIG. 17. Other methods and couplings can be used to provide driven gears on one side or both sides of the drive unit 602.

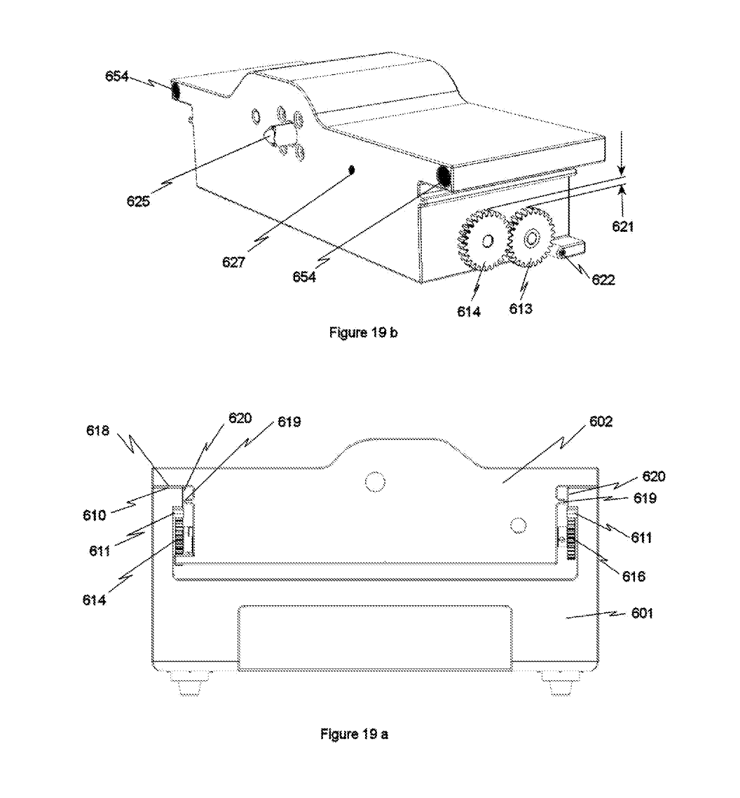

FIG. 19a is a cross section taken through A-A, indicated in FIG. 16b. The housing 601 and the drive unit 602 are shown. The drive unit 602 slides in from the rear of the housing 601 so that the bearing surfaces 610 and 618 are in contact with each other on both sides, and the gears 614, 616 are disposed beneath the housing rail and mesh with the gear racks 611. In this manner, the drive unit 602 is captured in the vertical direction. Protrusions 619 in the drive unit 602 ride against the inner wall 620 of the housing rail to keep the drive unit 602 located centrally within the housing 601. FIG. 19b is an isometric view of the drive unit. In this view it can be seen that the drive gear 613 and driven gear 614 are offset in the vertical direction by a distance 621. This ensures that only the driven gear 614 makes contact with the gear rack 611. When the drive motor is energized and rotates the drive gear 613, the driven gears 614 counter-rotate and drive the unit 602 along the rack 611. Reversing the motor direction reverses direction of the drive unit 602. This moves the drive unit 602, as well as the slicing platform 604, back and forth as shown in FIGS. 16a and 16b. In other embodiments, the drive gear 613 may be disposed within the drive unit 602.

To provide feedback to the controller and ensure that the drive unit has travelled its full stroke, a sensor may be used to determine the end points of travel. Many types of sensors can be used, such as mechanical and optical switches. In one embodiment, a magnetic reed switch, such as part number MK20/1-B-100W from Digi-Key, is used. This switch 622 (seen in FIG. 19b) is mounted into a boss on one side of the drive unit 602. Magnets 623 (see FIG. 17) are mounted into the side walls of the housing 601. When the switch 622 in the drive unit 602 passes in front of the magnet 623, it senses the presence of the magnet 623 and signals the controller, which de-energizes the drive motor and stops or reverses travel. The magnets 623 are located in positions to define each limit of the drive unit travel.

Referring back to FIG. 18b, the drive unit 602 comprises an electric motor 624 that rotates a drive shaft to reciprocate the blade. This motor can be of any suitable design, such as DC brush motor part number 9236S008-R1, supplied by Pittman Motors. This motor 624 is mounted onto the front wall of the drive unit 602 with the shaft protruding through the front wall. Mounted on the motor shaft is a coupling 625 that accepts the blade drive shaft.

A thickness actuator 626 may also be disposed in the drive unit 602, and used to adjust the thickness of the sliced food product. This actuator 626 mounts into the front wall of the drive unit 602 in a manner that allows the actuator shaft to pass through a hole 627 (see FIG. 19b) in the front wall. One suitable device is a linear actuator driven by a stepper motor with a 1 inch travel such as part number 25443-12-910, supplied by Haydon Kerk Motion Solutions, although other components can also be employed.

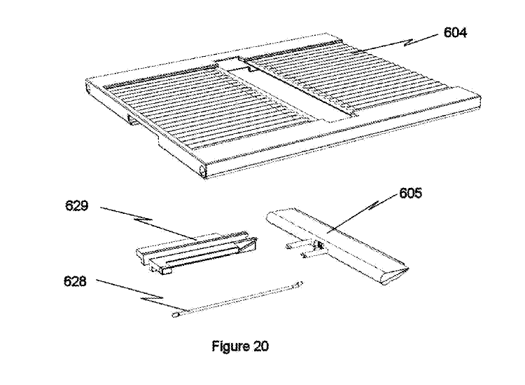

FIG. 20 shows the components that make up the slicing platform assembly. The slicing platform assembly comprises the slicing platform 604, the slicing blade assembly 605, the blade drive shaft 628 and the thickness drive block 629.

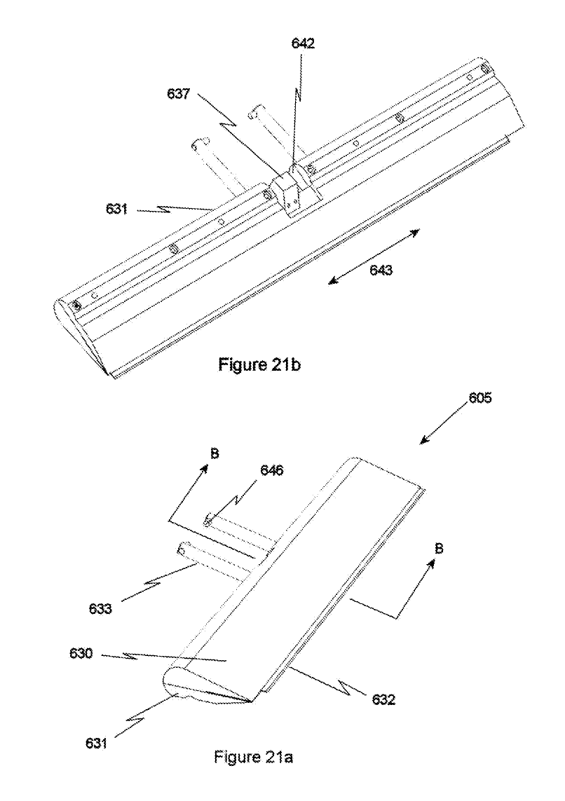

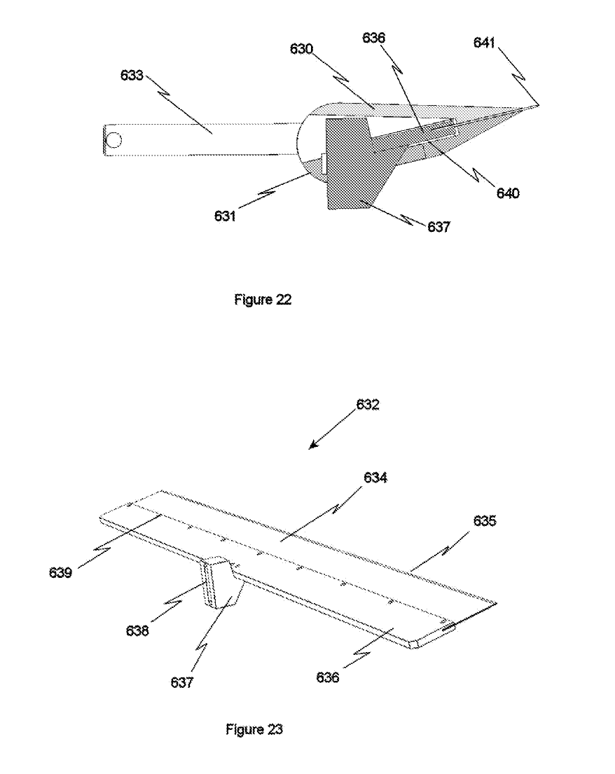

FIG. 21a is an isometric top view, FIG. 21b is an isometric bottom view, and FIG. 22 is a cross section taken through B-B of FIG. 21a, of the slicing blade assembly 605. The assembly 605 comprises an upper housing 630, a lower housing 631 and blade 632. Thickness control arms 633 are fixedly attached to one of the housings, such as the upper housing 630.

FIG. 23 shows the blade 632 removed from the housings 630, 631. The knife edge 634 is preferably stainless steel with a sharp edge 635 ground onto the leading edge. This knife edge 634 can also be made from other metals, ceramics, or plastics. The knife edge 634 is attached to the blade support 636. The blade support 636 is preferably made from a suitable plastic, such as nylon or acetal. A drive block 637 is also fixed to the blade support 636. The drive block 637 has an elongated slot 638 that is used to drive the blade 632 within the blade assembly 605. This block 637 can be made from any suitable plastic or metal material. Assembly of the blade 632 can be accomplished in multiple ways. In one embodiment, screws 639 are used to attach the knife edge 634 and drive block 637 to the blade support 636. Other attachment methods include adhesives or ultrasonic welding. The support 636 and drive block 637 can be molded as a unit, with the knife edge 634 attached or overmolded to it. If a plastic knife edge is used, the entire blade 632 can be molded as an integral unit.

When assembled, the blade 632 is sandwiched between the upper and lower housings 630, 631, where it is disposed in a cavity 640. The knife edge 634 protrudes through a slot and extends out from the leading edge of the blade assembly 641. The surfaces of the blade support 636 function as bearing surfaces within the housing cavity. The lower housing 631 has a relieved area 642 (see FIG. 21b) that allows access to the drive block 637 by the drive shaft (not shown), and also allows the blade 632 to reciprocate in the direction 643 within the housings. In some embodiments, the blade 632 includes a means to retract the knife edge 634 so that it does not protrude through the slot in the housings. This can be used as a safety measure when replacing the blade or servicing the apparatus, as it removes the sharp edge from the blade.

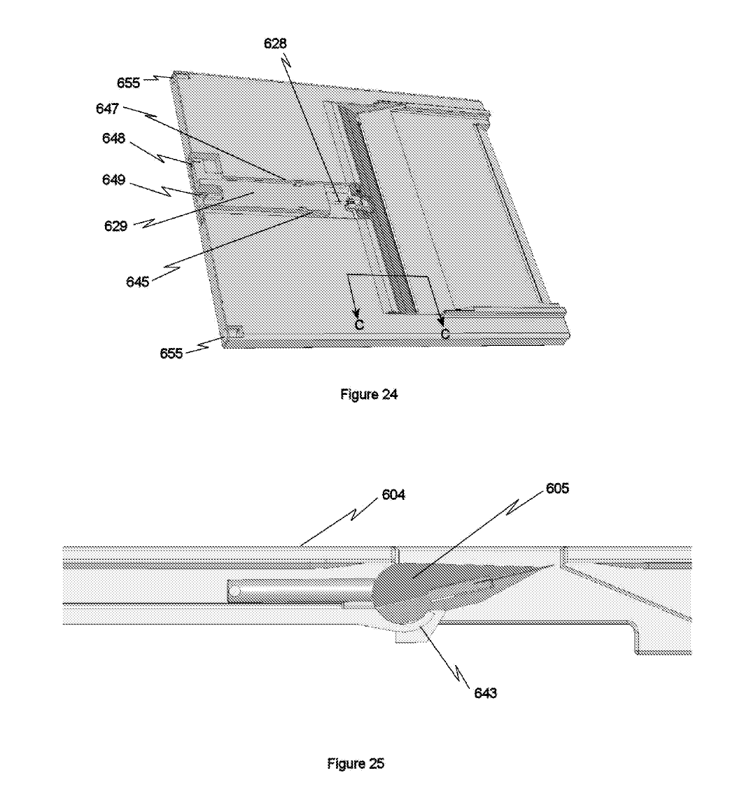

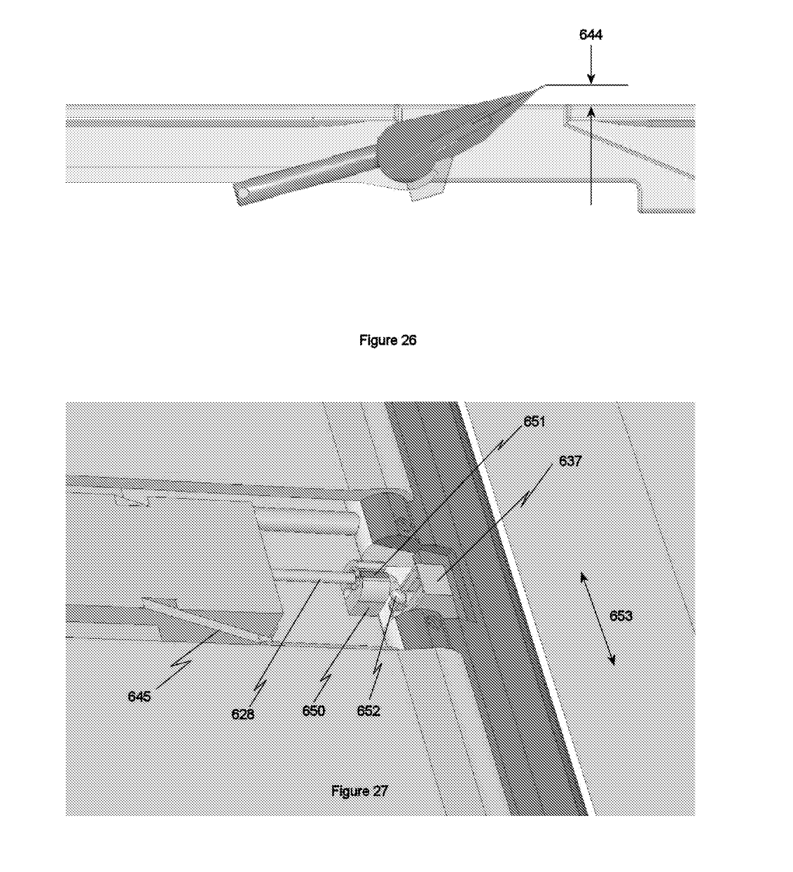

FIG. 24 is an isometric bottom view of the assembled slicing platform. FIG. 25 is a section view through C-C of FIG. 24. Blade 605 is disposed in the slicing platform 604. The blade 605 is held in place by a curved section 643 that captures the curved shape of the blade housings 630, 631. This attachment mechanism allows only one axis of motion for the blade housings, which is to rotate within the curved section. FIG. 26 shows the same section with the blade rotated. The distance 644 that the blade 605 projects above the platform 604 controls the thickness of the sliced food product. FIG. 25 shows the blade 605 in the fully lowered position, where the knife edge is below the surface of the slicing platform 604. In this position, the sharp edge of the knife edge is not accessible. This position provides an additional safety feature.

FIG. 24 also shows the thickness drive block 629 in place. FIG. 27 is a close-up view of the blade drive. Angled slots 645 are machined into the forward end of the block 629. These slots 645 receive the pins 646 (see FIG. 21a) in the thickness control arms 633. Flats on the thickness drive block 629 slide in grooves 647 in the slicing platform. As the thickness drive block 629 is moved forward and rearward by the thickness actuator 626, the pins 646 in the thickness control arms 633 rise and fall as they follow the angled slots 645, resulting in raising and lowering the blade knife edge as seen in FIGS. 25 and 26. The thickness drive block 629 is driven by the thickness actuator 626 in FIG. 17b. The drive block 629 can be constructed of a metal, preferably aluminum, or a suitable plastic. A magnet 648 (see FIG. 24) is mounted in the thickness drive block 629 and mates with the end of the thickness actuator shaft. The magnet 648 is sized to have enough attractive force to retain contact with the actuator shaft to act as a unit when the actuator returns the drive block 629 to the lower position, but still allow the platform assembly 604 to be easily removed from the housing 601. In this embodiment, the travel distance of the drive block 629 is one inch to move the knife edge from fully down to fully up.

Also visible in FIGS. 24 and 27 is the blade drive shaft 628. The first end 649 of the drive shaft is configured in such a way as to easily mate with the coupling 625 shown in FIG. 19b. In this embodiment, the first end 649 of the drive shaft has a flat that easily enters the tapered end and slot of the coupling 625. The slicing platform 604 contains a boss 650 with a feature that can hold the drive shaft 628 and a bearing 651. The distal end of the drive shaft 628 has two 90° bends 652 (see FIG. 27) that create an offset. The end of the offset enters the elongated slot 638 in the blade drive block 637. As the drive shaft 628 rotates, the circular motion of the offset end of the drive shaft in the elongated slot 638 causes the blade to reciprocate in direction 653 within the blade housings, resulting in a slicing action.

Referring back to FIG. 19b, the drive unit 602 contains a magnet 654 on each end of the front face. These magnets 654 mate to metal inserts 655 shown in FIG. 24. The attraction between the magnets 654 and metal inserts 655 couple the slicer platform 604 to the drive unit 602. This causes the platform 604 and drive unit 602 to move together as the drive unit is driven. The magnets 654 are sized to have enough attractive force to retain contact between the platform 604 and drive unit 602, so they act as a unit when driven, but still allow the platform assembly 604 to be easily removed from the housing 601.

FIG. 28 is an isometric view of the base 656 of the slicer 600. The base 656 comprises an enclosure 657, which may be generally made from sheet metal. Within the enclosure 657 and not visible are the circuit board, controls, wiring, connectors, etc., necessary to perform the functions of the slicer 600. In embodiments that use multiple slicers in one installation, common components can be grouped and centralized external to the base 656. For example, one power supply may be used to power multiple units.

Rubber feet 658 help to isolate sound and vibration from the apparatus to the surface on which it is placed.

In some embodiments, load cells 659 are disposed on the raised section. These load cells 659 are used in combination to weigh the sliced food product. When the weigh scale cover 606 (see FIG. 15b) is placed atop the base 656, it contacts and is supported by the load cells 659. The force on the load cells 659 is combined to ascertain the weight of the sliced product. This type of load cell 659 is common in the art. in some embodiments, the slicer 600 may also include four additional load cells 660 (only two visible) in each corner of the base 656. These load cells 660 are used to weigh the remainder of the slicer 600. It may be preferable to locate the load cells in these locations, rather than including the load cells in the feet of the apparatus as previously disclosed, since this configuration eliminates the weight of the base 656 as well as the sliced product. When the housing 601 is placed on the base 656, it is supported by the load cells 660. These load cells 660 are used to weigh the housing, slicing platform assembly, drive unit, food product holder and unsliced food product. Also visible in this view are the electrical power connection 661 and output to the drive unit 662. These connect by cables (not shown).

In use, prior to placing a food product into the food product holder, a tare weight is read that comprises the portion of the slicer 600 that is supported by the load cells 660. When the food product is then placed into the holder, the system can determine the weight of the food product and know how much unsliced product remains. Since the sliced product weigh scale is part of the base 656, sliced product that is dropped onto it during slicing is no longer weighed by the load cells 660.

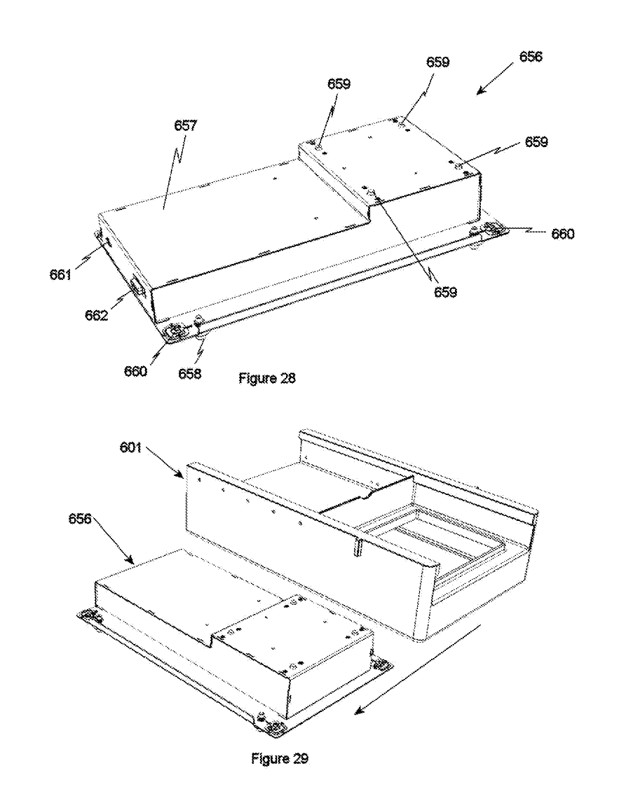

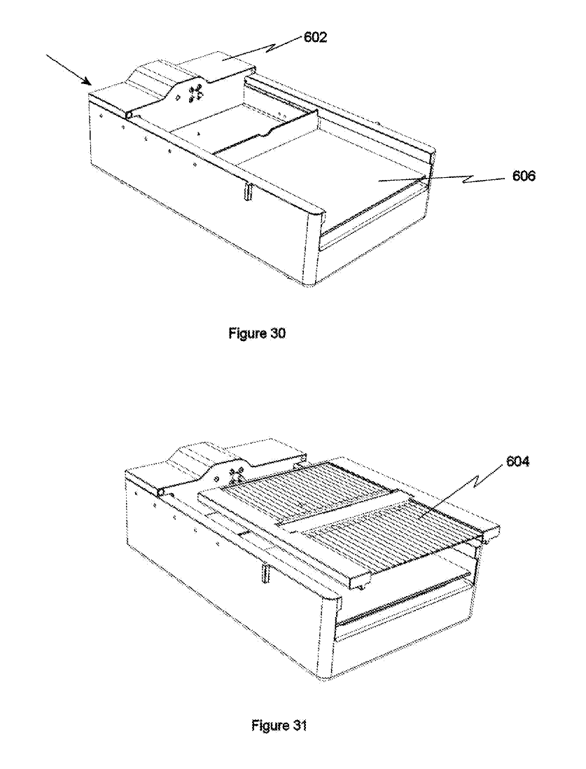

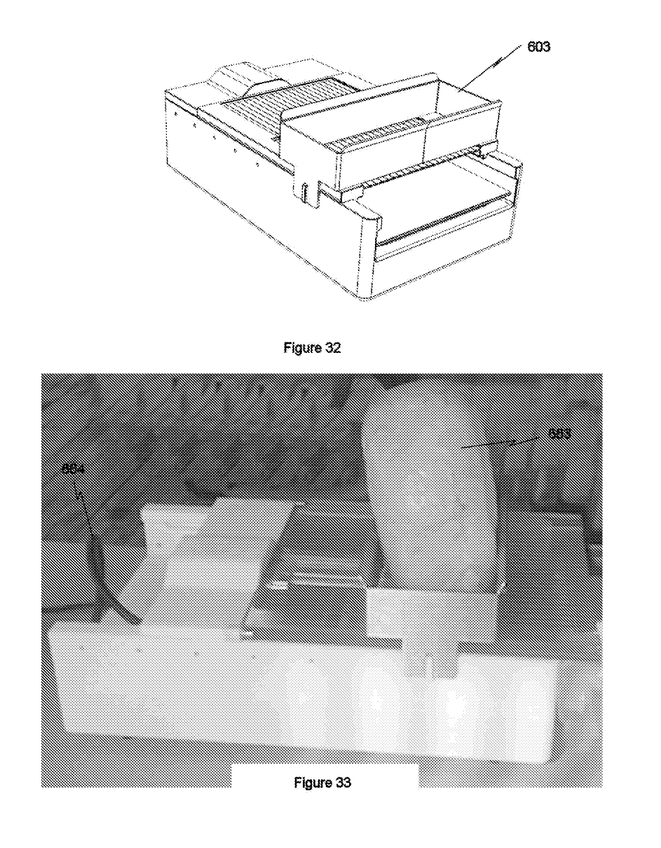

An advantage of the current embodiment is the ability to assemble and disassemble the apparatus quickly without the need for any tools. This is advantageous for ease of cleaning, maintenance or repair. The assembly will now be reviewed. FIG. 29 shows the base 656 and housing 601. The housing 601 is simply placed on the base 656. In FIG. 30, the drive unit 602 has been inserted from the rear of the unit. At this point, its cable is plugged into the connector 662. The weigh scale cover 606 may also be placed onto the base 656. In FIG. 31, the slicing platform assembly 604 is placed on top of the housing 601 and pushed rearward. This action engages the drive shaft with its coupling, engages the thickness drive block's magnet with the end of the thickness actuator shaft, and engages the slicing platform's magnets with the inserts in the drive unit. In FIG. 32, the food product holder 603 is placed onto the tabs in the housing 601. The slicer is now ready to use. Disassembly of the slicer is the reverse of assembly.

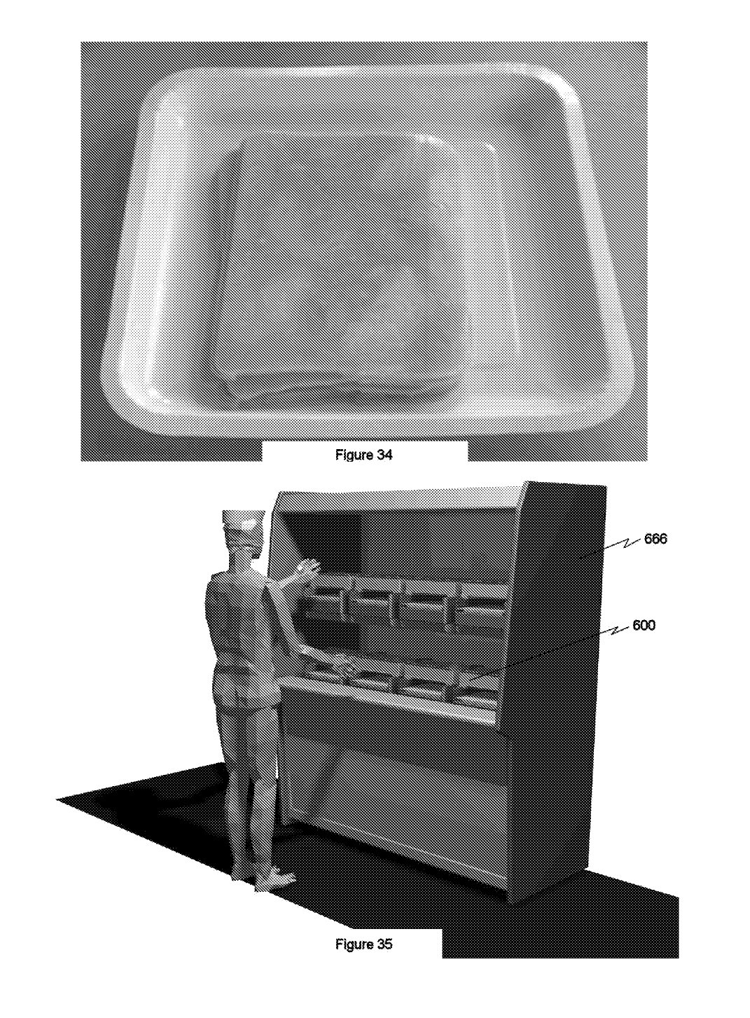

FIG. 33 shows the slicer in use, slicing a food product 663 that has been placed into the food product holder. In this view the cable connecting the drive unit to the base 664 is also visible. FIG. 34 shows the sliced product in a collection tray as it comes out of the slicer.

FIG. 35 illustrates an embodiment of a multiple slicer installation. A cabinet 666 holds a number of slicers 600. The cabinet 666 is preferably refrigerated so that food product may remain loaded in the slicers 600 until consumed. This figure shows an eight slicer installation, however the cabinet may be built to hold any number of slicers desired.

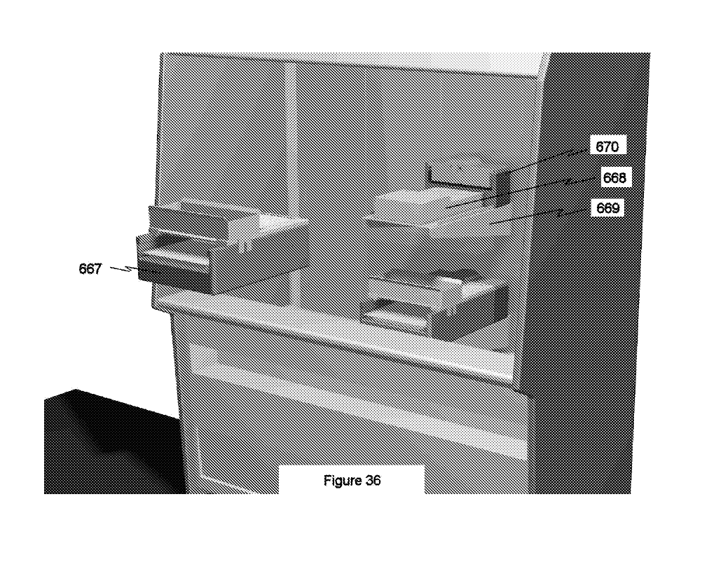

The slicers 600 may be placed onto shelves within the cabinet 666. FIG. 36 shows an alternative method of mounting and construction of the slicers 600 in the cabinet 666. The housing, slicing platform and food product holder 667 is shown removed from the remainder of the slicer. Brackets 669 are mounted into the back wall of the cabinet 666. These brackets 669 support the base 668 and, in this embodiment, a rear section of the housing 670 that includes the ability to park the drive unit 602. This makes for easy removal of the parts of the slicer 600 that require frequent cleaning or easy replacement. Other methods of supporting the slicers 600 are also envisioned, such as using two rods mounted lengthwise between the cabinet side walls and adding a mating shape into the slicer base to support and secure the slicers onto the rods. Other methods, such as a combination of rods, brackets, hooks, etc., may also be used.

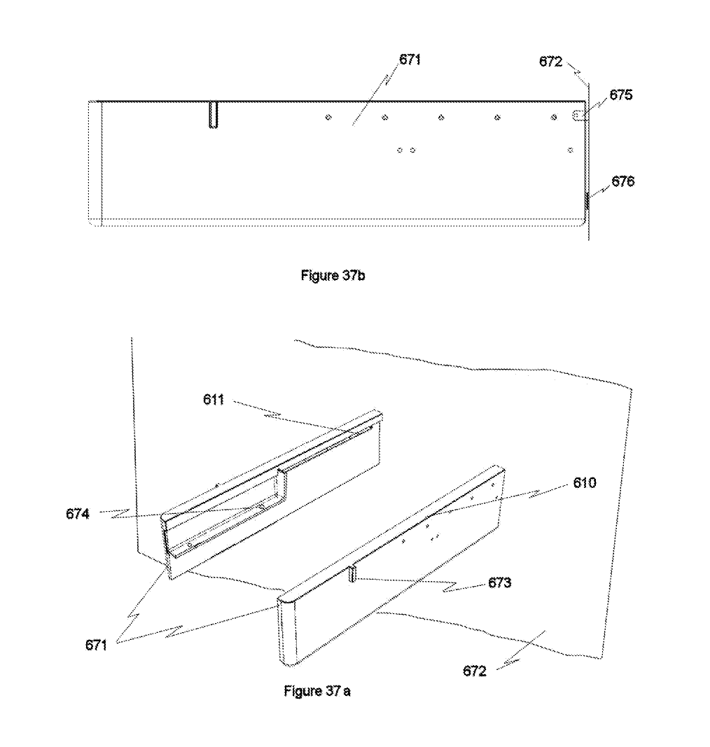

The modularity of the current invention lends itself to other assembly orientations as well. For example, FIG. 37a shows two rails 671 attached to the back wall 672 of a mounting location, such as a cabinet. These rails comprise the functional parts of the housing, including the upper bearing surface 610, gear racks 611, food product holder tabs 673, etc. Load cells 674 for the weigh scale may also be included as part of the rail. Alternatively, a weigh scale module (not shown) could be placed onto a scale shelf. The drive unit may be installed from the front of the rails, or by an alternative method. The slicing platform, food product holder and scale tray can all be installed as in previous embodiments. In this embodiment, the electronics and controls may all be contained behind the wall. FIG. 37b shows an additional embodiment in which the rail 671 is attached to the back wall 672 with a pivotable mount 675 that allows the rail to hang and apply force to a load cell 676 that is mounted to the back wall. The weight of the apparatus can be calculated by the force applied to the load cell 676. The weight of the remaining food product can then be known. This can be used with a sliced product scale that is part of the rail. Alternatively, the sliced food product may drop onto a platform mounted onto a separate attachment (not shown) below the apparatus. In this manner, the weight of sliced product can be determined by measuring the weight removed from the total apparatus.

As can be seen in all of these embodiments, the modularity of components and tool-less assembly of the current invention offer great advantages in the cleaning and servicing of the slicer. The slicer 600 can be broken down into its component parts quickly. The components can be easily cleaned, either manually or in an automatic ware washer. Rather than have the slicer be unusable during cleaning, previously cleaned components can replace the soiled ones, so that the slicer is out of service only momentarily. The soiled components can be cleaned at a convenient time. This is particularly advantageous if a different type of food product is to be loaded onto the slicer, for example, ham is to be replaced by cheese, especially during a busy time. Additionally, any inoperable or defective components can be replaced with new ones in moments, so the slicer 600 does not need to be idle while waiting for a service technician. A trained service technician is not needed to change components, as this can be accomplished by the slicer's operators. Defective components can be returned to the slicer's supplier for repair or reconditioning.

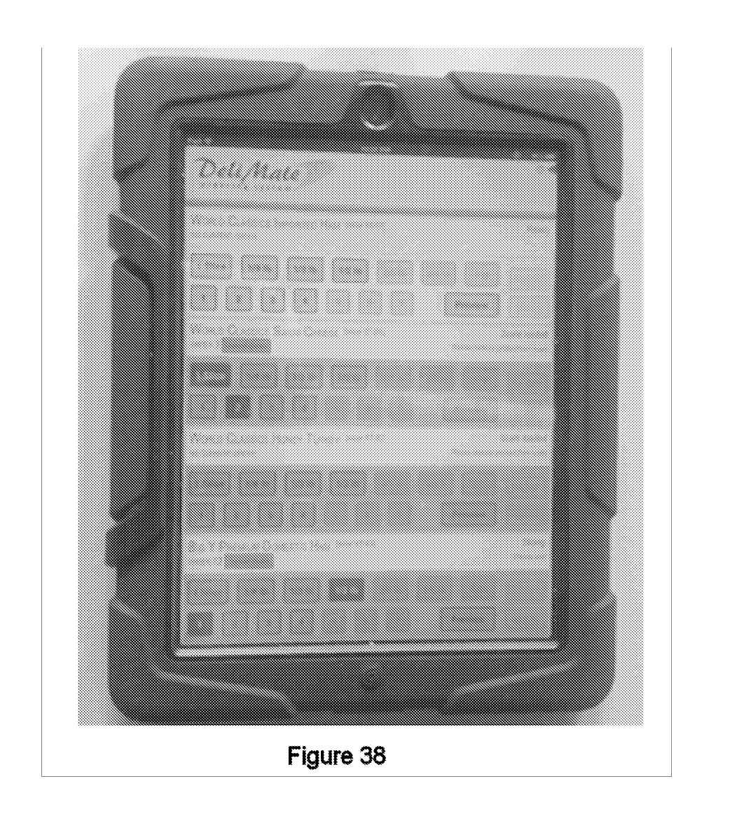

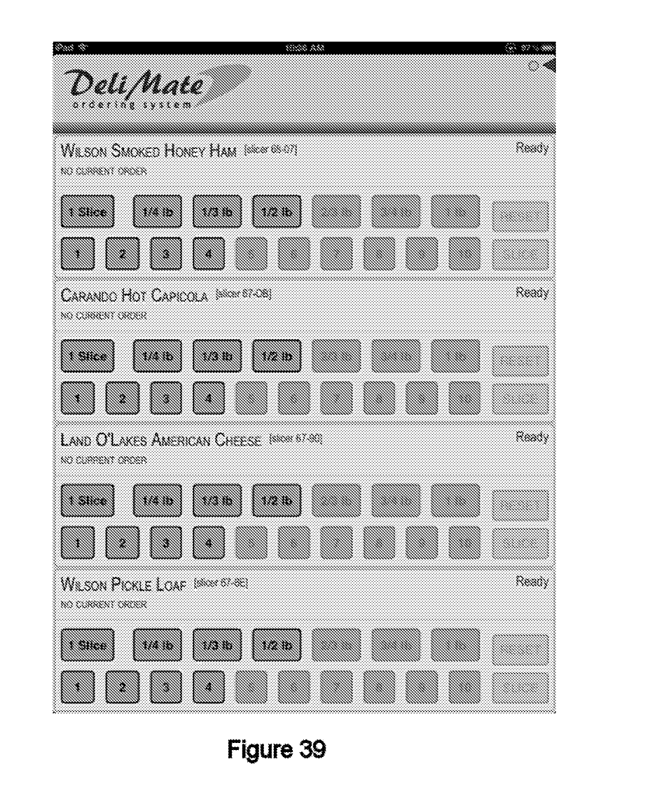

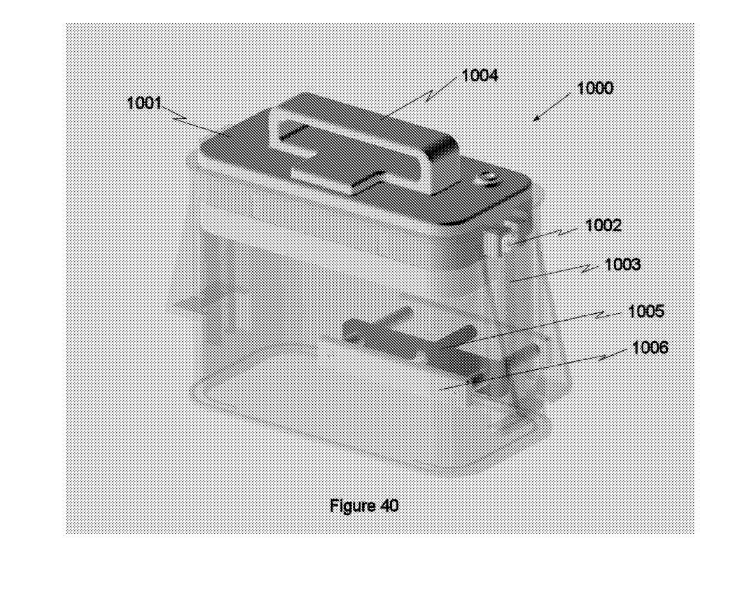

FIG. 38 shows an input device capable of sending orders to the slicers. This embodiment uses a tablet or other mobile computing device with a touch screen that connects wirelessly to the slicers, either directly or through a centralized slicer controller that controls all of the slicers. FIG. 39 is an example of one screen layout that may be used. The screen shows a selection of four types of food product. The user simply presses the icon for the amount and thickness of the desired product, then presses “slice.” The system then automatically slices the product. This is one example of the types of input screens that can be used. Adding more products may require the use of a menu tree, scrolling or other techniques. The system may utilize multiple input devices used by multiple users, and may also be used in conjunction with other types of inputs such as internet, smart phone aps, etc. If desired, the slicer 600 could include a user interface to allow direct input for slicing. In one embodiment, there are no user-accessible controls or adjustments. This eliminates failures due to operator error. Additionally, in one embodiment, there are no external knobs or controls that can capture food product residue, which makes cleaning easier and more thorough, resulting in a more sanitary device. Also, with no user-accessible controls, the slicer's safety is improved over current slicers since the operator has no reason to be touching or even in the proximity of the slicer during operation.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. An apparatus for slicing a food item, comprising:
a blade to slice the food item;
a collection platform for collecting the food item as it is sliced; and
a tray on which the food item rests, such that there is no relative linear motion between the food item and the collection platform while the food item is being sliced.

2. The apparatus of claim 1, wherein the food item remains stationary and the blade moves toward and through the food item to slice the food item.

3. The apparatus of claim 1, wherein the food item and the collection tray move in unison and the position of the blade remains stationary.

4. The apparatus of claim 1, wherein the blade and the collection tray are separated by a vertical distance, and the distance is adjusted to facilitate stacking of the sliced food item.

5. The apparatus of claim 1, wherein the collection platform rotates to facilitate stacking of the sliced food item.

6. An apparatus for slicing a food item, comprising:
a reciprocating blade to slice the food item;
a collection platform for collecting the food item as it is sliced; and
a platform on which the food item rests.

7. The apparatus of claim 6, further comprising:
a knife assembly, comprising:
a upper and lower housing surrounding the reciprocating blade; and
an elongated slot disposed on the housing; and
a rotating drift shaft comprising an offset end, the offset end positioned within the elongated slot, such that rotation of the drive shaft causes linear motion of the reciprocating blade.

8. The apparatus of claim 6, further comprising:
a knife assembly, comprising:
a upper and lower housing surrounding the reciprocating blade, rotatable about a pivot;
arms extending from the housing away from the blade; and
pins extending from the arms; and
a thickness control subsystem comprising:
a linear actuator;
a thickness drive block in communication with the linear actuator, having angled grooves into which the pins extending from the arms are disposed, such that movement of the linear actuator causes movement of the thickness drive block, which in turn causes the pins to move up and down in the angled groove, resulting in rotation of the knife assembly.

9. An apparatus for slicing a food item, comprising:
a blade to slice the food item;
a collection platform for collecting the food item as it is sliced;
a weight measuring device, integrated with said collection platform to measure the weight of sliced food items;
a mechanism to move the blade relative to the food item so as to slice it; and
a controller in communication with the mechanism and the weight measuring device, configured to disable the mechanism when the weight of the sliced food item reaches a predetermined value.

10. The apparatus of claim 9, wherein the controller alerts an operator when the weight of the sliced food item reaches the predetermined value.

11. The apparatus of claim 9, comprising a second weight measuring device which allows the weight of the food item to be determined.

12. The apparatus of claim 11, wherein the controller alerts an operator when the weight of the food item is below a predetermined threshold.

13. An apparatus for slicing food item, comprising:
a housing, comprising rails and a rack disposed under the rails;
a moveable horizontal tray, resting on the rails of the housing,
a blade; and
a drive unit, comprising:
a first actuator in communication with a driven gear, where the gear engages with the rack to move the drive unit along the direction of the rails
a second actuator in communication with a drive shaft to reciprocate the blade;
a third actuator in communication with a thickness drive block which rotates the blade to adjust its height; and
a coupling to attach the drive unit to the horizontal tray.

14. The apparatus of claim 13, where the coupling is a magnet.

15. The apparatus of claim 13, comprising a base, the base comprising a controller in communication with the first actuator, the second actuator and the third actuator and configured to control the actuators to cut the food item at a predetermined thickness.

16. An apparatus for slicing food items, comprising:
a horizontally oriented blade to slice the food item;
a horizontal tray on which the food item rests; and
a horizontal collection platform located below the tray such that the food item falls to the collection tray as it is being sliced by the blade.

17. The apparatus of claim 16, wherein the horizontally oriented blade and the horizontal collection platform are separated by a vertical distance, and the distance is adjusted to facilitate stacking of the sliced food item.

18. The apparatus of claim 16, wherein the horizontal collection platform rotates to facilitate stacking of the sliced food item.

19. An apparatus for slicing food items, comprising:
a tray to hold the food item;
a blade to slice the food item;
a collection tray to hold the slice food item;
a first weight measuring system to measure a weight of the sliced food item;
a second weight measuring system to measure a weight of the food item remaining of the tray; and
a controller in communication with the first weight measuring system, the second measuring system and the blade.

20. The apparatus of claim 19, wherein the controller disables the blade when the weight of the sliced food item reaches a desired value.

21. The apparatus of claim 19, wherein the controller alerts an operator when the weight of the food item remaining in the tray decreases below a predetermined value.

22. The apparatus of claim 19, wherein the first weight measuring system comprises load cells disposed beneath the collection tray.

23. The apparatus of claim 19, further comprising
a base to support the apparatus,
wherein the second weight measuring system comprises load cells disposed beneath feet of the base.

24. The apparatus of claim 19, further comprising
a base to support the apparatus, and
a housing resting on the base, which supports the tray and the blade,
wherein the second weight measuring system comprises load cell disposed on the base where the housing rests.
